(19) United States
(12) Patent Application Publication
(10) Pub. No.: US 2026/0143408 A1
(43) Pub. Date: May 21, 2026

(54) SPACE-BASED INTERNET HOSTING

(71) Applicant: Hughes Network Systems, LLC, Germantown, MD (US)

(72) Inventors: Satyajit Roy, Gaithersburg, MD (US); George Choquette, Germantown, MD (US)

(21) Appl. No.: 18/954,585

(22) Filed: Nov. 21, 2024

(51) Int. Cl. H04W 40/30; H04B 7/185; H04L 45/00; H04L 45/021; H04W 40/20

(52) U.S. Cl. CPC H04W 40/30; H04B 7/18584; H04L 45/021; H04L 45/22; H04W 40/20

(57) ABSTRACT

Methods, systems, and apparatus, including computer programs encoded on computer storage media, for applying intelligent routing techniques. In some implementations, a system obtains, from a satellite communication network, trajectory information for a device configured to communicate with an Internet host located in space. The system determines a first path for communication between the device and the Internet host located in space, wherein the first path includes one or more links. The system predicts a future disruption of a particular link in the first path. Based on the prediction, the system generates a routing table that defines a second communication path between the Internet host located in space and the device, wherein the second communication path configured to avoid the disruption of the particular link. The system provides, to the device, the routing table to enable the device to communicate with the Internet host over the second communication path.

### TECHNICAL FIELD

This specification relates generally to communication systems, including systems that route communications to servers located in space and on Earth over a combination of various terrestrial and satellite networks.

### BACKGROUND

Communication systems often attempt to meet the demands of clients with minimal disruptions to the clients. For example, satellite communication systems enable client devices to work collectively with ground stations and satellites, such as a low-earth orbit (LEO) satellite or a geosynchronous (GEO) satellite, to receive and send communications to other devices in a satellite communication network.

### SUMMARY

In some implementations, a communication system can apply intelligent routing techniques for communications across different network types. The different network types can include terrestrial networks and various satellite networks in space. The communication system can intelligently route communications over terrestrial networks, over satellite networks, or over a hybrid network that spans both terrestrial networks and satellite networks in space. In order to route communications over the satellite networks or over the hybrid network, the communication system leverages tracking and prediction of satellite trajectories, the positions of satellites, and potential disruptions to communications in space to identify routes that minimize delays to clients.

In some cases, an Internet host or server is located in space and is connected in a satellite network. A client device on the ground or in space may seek to communicate with the Internet host that is located in space. The communication system can intelligently route communications from the client device to the Internet host or server that is located in space through connections in one or more networks. For example, a client device on the ground may communicate in a first network, e.g., a terrestrial network, that connects to a second network, such as a satellite network, to communicate with the Internet host located in space, e.g., in a geosynchronous or geostationary (GEO) network or in a low earth orbit (LEO). The communication system can analyze the locations of satellites, client devices, and other components to determine how to route the communications to and from Internet hosts in space, including potentially through a variable number of links or hops between satellites.

Due to the movement of satellites, client devices, rotation of the earth, and other factors, the available routes to an Internet host in space will change over time. For example, different satellites will enter and exit line-of-sight ranges, obstructions may come and go, solar radiation and other interference sources can vary, and weather patterns can vary signal quality to ground stations. To avoid or mitigate these issues, the communication system can vary the routing paths that communications take through space to achieve efficient and reliable connections. For example, the system can use known trajectories of satellites to predict the future positions and signal quality conditions that will be present. The system can use these predictions to generate different routes for different devices (e.g., ground terminals, gateways, servers in space, client devices in space, satellites, etc.) to reach each an Internet host. For example, devices at different positions and different trajectories will sometimes be given different routes to reach the same Internet host in space, in order to optimize the latency, throughput, power efficiency, reliability, and other performance characteristics. The system can repeatedly update the routes provided to the devices, such as proactively issuing new routes to devices to account for detected and/or predicted movement and other conditions.

In general, the communication system can generate and predict routing to enable ongoing connectivity among ground-based and space-based devices. This can include repeatedly generating and distributing routing tables to endpoints to enable connectivity to Internet hosts or servers located in space. For example, the system can support communications from devices on the ground to devices in space, from devices in space to devices on the ground, from devices in space to other devices in space (potentially entirely through satellites or space-based devices, or through a combination of satellite and ground networks), from devices on the ground to other devices on ground through connections with satellites, and so on.

In some implementations, an astronaut on a space station can communicate with a ground station located on the Earth using the satellite networks in space provided by the communication system. In this case, the astronaut may seek to access an Internet host, or a server located on the Earth. The communication system can route the communications over a hybrid network that allows the astronaut, in this example, to send communications from the satellite-based network in space to the terrestrial network on Earth. The communication system can route the communications over the hybrid network utilizing various Internet protocol techniques, satellite communication techniques, and intelligent routing standards that allow communications to traverse ground-based networks, space-based networks, or both types of networks.

In some implementations, the communication system can enable a client device located on the ground or located in space to access an Internet host on the ground. In some implementations, access to the Internet host in a terrestrial network may involve either routing communications only through the satellite network in space, routing communications only through the terrestrial network on the ground, or routing communications in a hybrid manner that traverses both space and ground segments.

In some implementations, the Internet hosts in space can be located in various orbits. For example, the Internet hosts in space can be located on a satellite in a GEO orbit, on a satellite in a low earth orbit (LEO), or on a satellite in a Medium Earth orbit (MEO), to name some examples. The communication system can enable a client device located in a particular network, e.g., terrestrial, LEO, MEO, or GEO, to access to an Internet host located in any one of the aforementioned networks. In this manner, the communication system can provide communication functionality across a hybrid network platform that is not limited to only ground-based communication or only satellite-based communication.

In order to route communications from the client device to the Internet host, the communication system can determine how to route communications only through the space network or through hybrid routing, which spans both the satellite network in space and the terrestrial network segments. The communication system can determine an efficient route for communication to travel from the client device to the Internet host according to satellite movement, obstructions, solar radiation, and weather patterns, to name a few examples. Using the determined efficient route, the communication can propagate these routes to the devices, and can repeatedly update these routes to account for additional obstructions, satellite movements, and others. In some implementations, a client device seeking to access the Internet host in space may be able to directly access the Internet host in space or may require communication through a terrestrial network to a ground station, which can subsequently communicate with the Internet host in space.

In one general aspect, a method includes: obtaining, from a satellite communication network, trajectory information for a device configured to communicate with an Internet host located in space; determining a first path for communication between the device and the Internet host located in space, wherein the first path includes one or more links among nodes in a network; predicting a future disruption of a particular link of the one or more links in the first path; based on the prediction of the future disruption of the particular link, generating, for the device, a routing table that defines a second communication path between the Internet host located in space and the device, wherein the second communication path configured to avoid the disruption of the particular link; and providing, to the device, the routing table to enable the device to communicate with the Internet host in space over the second communication path.

Other embodiments of these and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the method includes providing, to multiple devices, the routing table to table each device of the multiple devices to communicate with the Internet host in space over the second communication path.

In some implementations, the method includes: based on the prediction of the future disruption of the particular link, generating, for multiples devices, a respective routing table that defines a respective second communication path between the Internet host located in space and each respective device of the multiple devices, wherein each respective second communication path is configured to avoid the disruption of the particular link; and providing, to each device of the multiple devices, the respective routing table to enable the respective device to communicate with the Internet host in space over the respective second communication path.

In some implementations, the method includes: determining a respective path for communication between multiple devices and multiple respective Internet hosts located in space, wherein the each respective path includes one or more links among nodes in a network; predicting a future disruption of a particular link of the one or more links in a respective path; based on the prediction of the future disruption of the particular link, generating, for each device, a respective routing table that defines a respective communication path between a respective Internet host located in space and a respective device, wherein the respective path is configured to avoid the disruption of the particular link; and providing, to each device, the respective routing table to enable the respective device to communicate with the respective Internet host in space over the respective path.

In some implementations, the method includes providing, to the device, data indicating a start time and end time for the device to utilize the routing table.

In some implementations, the device of the satellite communication network includes a ground station, a client device, or a satellite.

In some implementations, obtaining the trajectory information for the device configured to communicate with the Internet host in space includes: determining a trajectory of a satellite in the satellite communication network; determining a geographical location of a ground station on earth; and determining a geographical location of a client device on earth.

In some implementations, predicting the future disruption of the particular link of the one or more links in the first path includes one or more of: predicting terrestrial network congestion on the one or more links that satisfies a first threshold value; predicting latency over the one or more links that satisfies a second threshold value; predicting packet loss over the one or more links that satisfies a third threshold value; predicting satellite network disruption over the one or more links according to the trajectory of the one or more satellites misaligning with the one or more client devices; predicting an eclipse or solar outage that will likely impact the communication between the device and the Internet host; and predicting satellite network congestion over the one or more communication pathways that satisfies a fourth threshold value.

In some implementations, generating, for the device, the routing table that defines the second communication path between the Internet host located in space and the device includes replacing a satellite in the first path for communication between the device and the Internet host with one or more other satellites in the second communication path.

In some implementations, generating, for the device, the routing table that defines the second communication path between the Internet host located in space and the device includes replacing a gateway in the first path for communication between the device and the Internet host with at least one of a different gateway and one or more additional satellites in the second communication path.

In some implementations, generating, for the device, the routing table that defines the second communication path configured to avoid the disruption of the particular link includes: determining, for the device and for a current or future time, whether a communication pathway exists to the Internet host in space through one or more of a ground station and a satellite; determining, for each of one or more ground stations and for a current or future time, whether a communication pathway exists to the Internet host in space through one or more of the satellites; determining, for each of the one or more ground stations and for a current or future time, whether a communication pathway exists to the Internet host in space; and storing, in the routing table and for the device, the one or more ground stations, and the one or more satellites, a respective list of addresses of corresponding devices that enable communicating with the Internet host in space.

In some implementations, storing, in the routing table and for the device, the one or more ground stations, and the one or more satellites, the respective list of addresses includes generating, for each of the device, the ground station, and the satellite, a segment routing version 6 (SRv6) segment ID (SID) list for the respective list of addresses, the SRv6 SID list instructing each device one or more subsequent devices to communicate with for sending communications to the Internet host in space.

In some implementations, determining whether the communication pathway exists to the Internet host in space using the device, the ground station, and the satellite includes determining whether communication traffic flows from the device to the Internet host in space through at least one of the ground station, the satellite, or the ground station and the satellite.

In some implementations, generating the routing table that defines the second communication path between the Internet host located in space and the device includes generating the routing table that defines the second communication pathway causing the device to communicate with the Internet host located in space utilizing at least one of a terrestrial network, a satellite network, and a hybrid network that includes the terrestrial network and the satellite network.

In some implementations, the method includes: determining trajectory information for the Internet host located in space in a GEO orbit; determining whether the device includes a capability to communicate with the Internet host located in space; and in response to determining that the device includes the capability to communicate with the Internet host located in space, generating, for the device, the routing table that defines the second communication path from the device to the Internet host located in space in the GEO orbit.

In some implementations, the method includes: determining trajectory information for the Internet host located in space in a GEO orbit; determining whether the device includes a capability to communicate with the Internet host located in space in the GEO orbit; in response to determining that the device does not include the capability to communicate with the Internet host located in space: determining trajectory information of one or more satellites in LEO orbit; using the trajectory information, determining which of the one or more satellites in the LEO orbit the device views; and in response, generating, for the device, the routing table that defines the second communication path from the device to the Internet host located in space in the GEO orbit using the one or more satellites in the LEO orbit the device views.

In some implementations, the method includes: determining trajectory information for the Internet host located in space in a GEO orbit; determining whether the device includes a capability to communicate with the Internet host located in space in the GEO orbit; in response to determining that the device includes the capability to communicate with the Internet host located in space in the GEO orbit, determining whether the device includes a capability to communicate with one or more LEO satellites; in response to determining that the device includes the capability to communicate with the one or more LEO satellites, generating, for the device, the routing table that defines the second communication path from the device to the Internet host located in space in the GEO orbit using the one or more LEO satellites as subsequent hops to the Internet host located in space in the GEO orbit.

In some implementations, the method includes: determining trajectory information for the Internet host located in space in a LEO orbit; determining whether the device includes a capability to communicate with the Internet host located in space in the LEO orbit; and in response to determining that the device includes the capability to communicate with the Internet host located in space in the LEO orbit, generating, for the client device, the routing table that defines the second communication path from the device to the Internet host located in space in the LEO orbit.

In one general aspect, a method includes: determining a power status of an energy source of an Internet host in space; comparing the power status to a first threshold value and a second threshold value, the second threshold value being greater than the first threshold value; determining that the power status satisfies the first threshold value and does not satisfy the second threshold value; in response to determining the power status satisfies the first threshold value and does not satisfy the second threshold value, generating a first value of a domain name service (DNS) Time to Live (TTL) for a route from the one or more client devices to the Internet host in space; and providing, to the one or more client devices, an address of the Internet host in space and the first value of the DNS TTL.

In some implementations, obtaining the power status of the energy source of the Internet host in space includes obtaining the power status of one or more batteries that power the Internet host in space.

In some implementations, the method includes: determining that the power status does not satisfy the first threshold value and does not satisfy the second threshold value; and in response to determining the power status does not satisfy the first threshold value and does not satisfy the second threshold value, providing, to the one or more client devices, data indicating that access to the Internet host in space is blocked.

In some implementations, the method includes: obtaining another power status of an energy source of an Internet host in space; comparing the other power status to a third threshold value and a fourth threshold value, the third threshold value being greater than the second threshold value and the fourth threshold value being greater than the third threshold value; determining that the other power status does satisfy the third threshold value and does not satisfy the fourth threshold value; and in response to determining the power status satisfies the third threshold value and does not satisfy the fourth threshold value, generating a second value of a DNS TTL for the Internet host in space for the one or more client devices seeking to communicate with the Internet host in space, the second value of the DNS TTL being greater than the first value of the DNS TTL.

In some implementations, the method includes: in response to an expiration of the first value of the DNS TTL, receiving, from a local client device DNS resolver, a request for a host name of the Internet host in space; and providing, to the one or more client devices, an address of another Internet host in space whose state of charge satisfies the threshold value.

In some implementations, the method includes: determining a time for an upcoming a solar eclipse that affects the Internet host in space from hosting communications from one or more client devices; generating a fourth value of a DNS TTL for the Internet host in space for one or more client devices seeking to communicate with the Internet host in space, the fourth value of the DNS TTL set to expire with a threshold time of the time for the upcoming solar eclipse; providing, to the one or more client devices, the address of the Internet host in space and the fourth value of the DNS TTL; in response to an expiration of the fourth value of the DNS TTL, receiving, from a local DNS, a request for a host name of the Internet host in space; generating a fifth value of a DNS TTL for the Internet host in space for the one or more client devices seeking to communicate with the Internet host in space, the fifth value of the DNS TTL that is set to expire at another time following an end of the solar eclipse; and providing, to the one or more client devices, the address of the Internet host in space and the fifth value of the DNS TTL.

In some implementations, the method includes: obtaining a third power status of an energy source of an Internet host in space; comparing the third power status to the first threshold value and the second threshold value; determining that the third power status does satisfy the first threshold value and does satisfy the second threshold value; comparing the third power status to a third threshold value and a fourth threshold value, the third threshold value being greater than the second threshold value and the fourth threshold value being greater than the third threshold value; determining that the third power status does satisfy the third threshold value and the fourth threshold value; and in response to determining the power status satisfies the third threshold value and the fourth threshold value, generating a third value of a DNS TTL for the Internet host in space for the one or more client devices seeking to communicate with the Internet host in space, the third value of the DNS TTL being greater than the first value of the DNS TTL.

In one general aspect, a method includes: obtaining, from a satellite communication network, trajectory information for devices that communicate with an Internet host in space, the devices include one or more client devices, one or more satellites, and one or more ground stations; determining an upcoming time when communication between the Internet host in space and one or more client devices is unavailable, wherein the one or more client devices are prevented from communicating with the Internet host in space through at least one of the one or more ground stations and the one or more satellites during a duration of an event at the upcoming time; prior to the upcoming time: identifying another satellite of the one or more satellites that provides an additional communication path for the one or more client devices to communicate with the Internet host in space during the duration of the event; generating, for the one or more client devices and the other satellite, a routing table that defines the additional communication path between the one or more client devices, the identified satellite, and the Internet host in space; and providing, to each of the one or more client devices and the other satellite, the routing table such that the one or more client devices communicate with the Internet host in space through the identified satellite during the duration of the event.

In some implementations, obtaining the trajectory information for the devices that communicate with an Internet host in space includes: determining a trajectory of the one or more satellites in the satellite communication network; determining a geographical location of the one or more ground stations on earth; and determining a geographical location of the one or more client devices on earth.

In some implementations, the event includes at least one of a solar eclipse, a sun outage, or a low battery of the Internet host in space.

In some implementations, the method includes obtaining, from a database and for the Internet host in space, the upcoming time for a solar outage and the duration of the solar outage, wherein the upcoming time for the solar outage and the duration of the solar outage are based on the sun being in a line of sight between the Internet host in space and at least one of the one or more ground stations or the one or more satellites.

In some implementations, the method further includes: identifying another ground station of the one or more ground stations that will be (i) unaffected by the event and (ii) enables the one or more client devices to communicate with the Internet host in space during the duration of the event; generating, for the one or more client devices and the other ground station, another routing table that defines a respective communication path between the one or more client devices, the identified ground station, and the Internet host in space; and providing, to each of the one or more client devices and the other ground station, the routing table such that the one or more client devices communicate with the Internet host in space through the identified ground station during the duration of the solar eclipse.

In some implementations, the method includes: following the duration of the event: generating, for the one or more client devices, the one or more satellites, and the one or more ground stations, a routing table that defines a respective communication path between the Internet host in space and the one or more client devices, the one or more satellites, and the one or more ground stations, the respective communication path being similar to a communication pathway used by the devices to communicate with the Internet host in space prior to the upcoming time of the event; and providing, to each of the one or more client devices, the one or more satellites, and the one or more ground stations, the routing table for communications with the Internet host in space.

In some implementations, the method includes rerouting traffic from the one or more client devices to the Internet host in space through at least one of a ground station and a satellite during the duration of the event.

The subject matter described in this specification can be implemented in various embodiments and may result in one or more of the following advantages. In some implementations, the communication system can improve communications between a client device and an Internet host when a current communication network is experiencing disruption. For instance, if the communication system detects that a terrestrial network that the client device and the Internet host typically communicate over is heavily congested, then communication system can seamlessly reroute traffic over one or more satellite networks that circumvents the heavily congested terrestrial network. In this manner, the communications between the client device and the Internet host can continue despite the disruptions on the heavily congested terrestrial network.

Moreover, storing Internet hosts in space stations rather than on the ground is more cost efficient. In further detail, the Internet hosts depend on free power from the sun and free cooling due to the coldness of space. In this manner, the Internet hosts can be powered independently using solar as one of the natural energy sources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1B are block diagrams that illustrate an example of systems for intelligently routing communications in a hybrid communication network.

FIG. 2A-2C are flow diagram that illustrate various examples of intelligently routing communications between a client device and a host on the ground using satellite networks.

FIGS. 3-4 and 6 are block diagrams that illustrate examples of systems for intelligently routing communications to an Internet host during a solar outage.

FIG. 5 is a block diagram that illustrates an example of a system for intelligently routing communications over terrestrial networks when the Internet host is located in LEO orbit.

FIG. 7 is a block diagram that illustrates an example of a system for intelligently routing communications from a client device in LEO orbit to an Internet host in a GEO orbit.

FIG. 8 is a flow diagram that illustrates an examples process for intelligently routing communications in a hybrid communication network.

Like reference numbers and designations in the various drawings indicate like elements.

### DETAILED DESCRIPTION

The specification describes a communication system that enables communications across terrestrial networks, satellite networks, and hybrid networks spanning both the terrestrial and satellite networks. The communication system can intelligently route communications from a device of a first network, e.g., a terrestrial network, to another device in a second network, e.g., a satellite network, and vice versa. The communication system can leverage predictable aspects of device movement and disruptions that may occur in order to intelligently determine communication routes from the device in the first network to another device in the second network.

The communication system enables a client device, which may be located on a satellite in Low-Earth Orbit (LEO), any other network, or a spacecraft, to access an Internet host, which may be located on a satellite in another network, such as a Geosynchronous (GEO) network. In this example, the communication system can route the communications from the client device in a LEO network to one or more terrestrial networks, one or more other satellites in a LEO network, or one or more satellites in a GEO network. The communication system can determine the route the communications can take according to various criteria, as will be further described below.

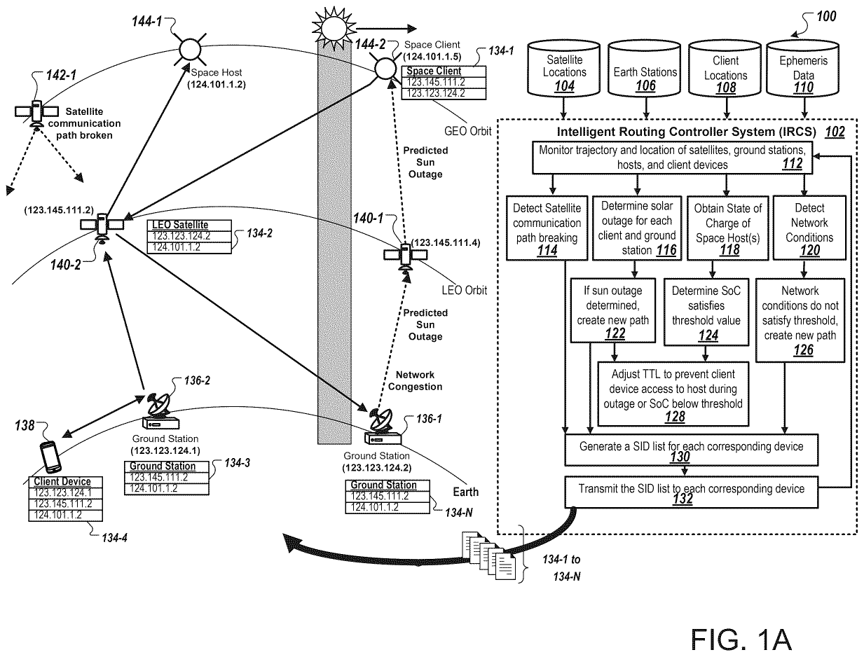

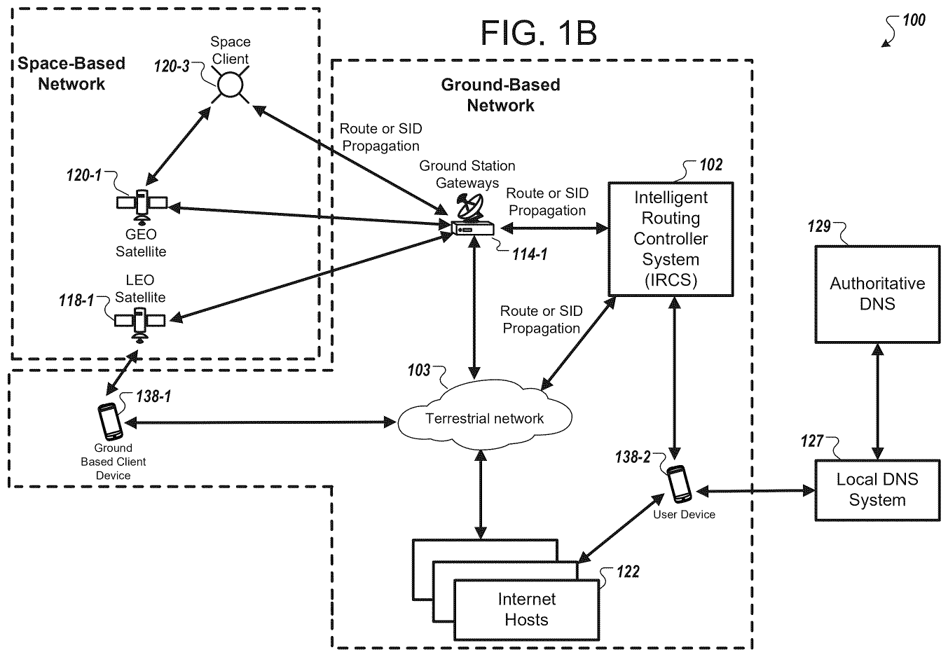

FIG. 1A is a block diagram that illustrates an example of a system 100 for intelligently routing communications in a hybrid communication network. The example of FIG. 1A illustrates communication types, e.g., satellite and terrestrial communication. The techniques described here can be applicable across other wireless communication systems and networks. FIG. 1A illustrates various operations, which can be performed in the sequence indicated, in another sequence, with fewer stages, or with more stages.

The system 100 includes an intelligent routing controller system (IRCS) 102 that communicates with various satellites, various ground stations, and various client devices. For example, the system 100 includes one or more client devices 138, various ground stations 136-1 and 136-2 (hereinafter “ground stations 136”), LEO satellites 140-1 and 140-2 (hereinafter “LEO satellites 140”), GEO satellites 142-1 (hereinafter “GEO satellites 142”), and space hosts 144-1 and 144-2 (hereinafter “space hosts 144”). These devices can cooperate to transfer data to and from one another according to instructions provided by the IRCS 102. In some cases, the IRCS 102 can provide routing tables to the devices in the system 100 that instructs the devices how to route traffic from one device to another, as will be further described below.

The IRCS 102 can include one or more computers, such as one or more servers, which perform functions related to generating and propagating routing tables, among other functions. The IRCS 102 can communicate with one or more external devices, networks, the ground stations 136, the LEO satellites 140, the GEO satellites 142, the space hosts 144, and the client devices 138. Moreover, the IRCS 102 can obtain data associated with satellite position and movement, solar position, ground station position, and client device position and movement, to aid in intelligently routing communications across the various devices.

In some implementations, the client devices 138 can be a device that can communicate with the ground stations 136, the IRCS 102, the LEO satellites 140, the GEO satellites 142, and any other device in the system 100. In some implementations, the client device 138 can include hand-held devices, telephones, laptop computers, desktop computers, Internet of Things (IoT) devices.

The client devices 138 can make use of the network service provided by a respective ground station. In some implementations, the client devices 138 can be capable of interfacing directly with a LEO satellite or a GEO satellite. However, if a client device 138 is not capable of interfacing directly with a LEO or GEO satellite, the client device can interact with a ground station, e.g., ground station 136-2, or a relay device that can interact with a LEO or GEO satellite.

In some implementations, the system 100 includes GEO satellites 144 which operate in the GEO orbit. The GEO orbit has an altitude of approximately 22,000 miles, for example. GEO satellite communication networks inherently have high latency due to long propagation delay but may cover a wider geographical area.

In some implementations, the LEO satellites 140 revolve around the Earth and operate in a LEO orbit. The LEO orbit has an altitude of approximately 1,200 miles or lower. In some cases, the system 100 can include dozens to hundreds of LEO satellites 140 to cover the same geographical area that can be covered by a single GEO satellite, which is one of the reasons why the LEO service is more expensive than the GEO service.

In some implementations, the system can include various MEO satellites, which operate in the MEO orbit. The MEO orbit has an altitude that is above the LEO orbit but below the GEO orbit. For example, the MEO altitude is approximately between 1,243 miles and 22,236 miles. Functionalities that are described with respect to the LEO satellites may also occur with respect to the MEO satellites.

In some implementations, the system 100 includes ground stations 136. The ground stations 136 are configured to communicate with LEO satellites 140, GEO satellites 142, space hosts 144, the IRCS 102, and various client devices 138, among others. In some cases, the ground stations 136 can relay data received from the client devices 138 to various satellites and Internet hosts in space. In some cases, the ground stations 136 can relay data from the various satellites and space hosts to client devices and other components in the system 100.

In some implementations, the system 100 includes space hosts 144. A space host 144 can be, for example, a space station. The space host 144 is a host that uses satellite, terrestrial, or hybrid networks to provide Internet connectivity. For example, the Internet host can include a web server, an email server, or any other kind of network server or server platforms of a cloud computing environment that resides in space, such as in a space station.

In some cases, a space host 144 can be located on different external planets, such as the Moon, Mars, Jupiter, or any other planet. In order for the space host 144 to successfully participate in the communication scheme offered by the system 100, the space host 144 requires access to publicly accessible Internet to provide Internet connectivity for various connected devices. However, in order to provide such publicly accessible Internet, there are several technical issues to be overcome and customizations to these components. The physical environment for an Internet host in space is different from the physical environment for an Internet host located on the ground.

For instance, when Internet hosts are located in space, such as on a space station, high performance processing in cold space on the Internet host is performed on a rental basis due to limited power availability. Space provides exceptionally low temperatures, which makes quantum computing processing possible. In such temperatures, quantum computing can lead to super high performance in various applications, such as medical and artificial intelligence. In some implementations, images captured from a space-based telescope is based on the paid user pointing up or down. In another example, the spaced based messaging/advertising is localized on the ground, if the messaging platform could be made large enough to make this feasible. In some examples, security applications are also possible for Internet hosts located in space.

As shown in system 100, the Internet hosts can be located in various orbits around the Earth, such as GEO, LEO, and even MEO. In some cases, the Internet hosts can be extended to various external planets. The Internet hosts can be accessed from a terrestrial network, from a satellite network, or from a hybrid network that spans both terrestrial and satellite networks. One or more ground stations 136, one or more client devices 138, and one or more satellites in various orbits, can access the Internet hosts in space using the terrestrial, satellite, or hybrid networks.

In some implementations, availability of power to run Internet hosts in space can vary over time but in a predictable manner. The IRCS 102 can analyze predictable patterns to determine power availability for the Internet hosts. For example, sun interference variability, eclipse occurrences, the orbital motion of Internet hosts in space in LEO, MEO, and GEO orbits around the Earth. Some of these events can affect power availability for the Internet host, such as an eclipse or sun outages where the LEO orbital motion affects routing. For example, during an eclipse or a sun outage, the rays of the sun may interfere with an antenna in a ground station, a client device, or a satellite, and negatively affects that device's receiving capabilities. The IRCS 102 may predict the occurrence of the eclipse to provide routing tables to devices to avoid communicating with the affected device. This will be further described below.

Some of these aspects may also apply to terrestrial hosts, but the difference between Internet hosts in space verse Internet hosts on the ground lies in the predictable nature of the characteristics of space. The IRCS 102 can monitor and analyze the predictable nature of the power availability characteristics in space to aid in determining routing paths for communications between client devices and Internet hosts in space.

For instance, any satellite constellation, e.g., GEO, MEO, or LEO, experiences a predicted eclipse and regular shadowing of the Sun events. The predicted eclipse and regular shadowing of the Sun events can also happen to a space craft. Therefore, a challenge exists to manage power for Internet hosts during these solar outage events. During these periods, the ability for an Internet host to solar charge is lost and the energy sources of the Internet hosts, e.g., batteries, drain at a faster pace than otherwise would if solar energy were available. This may result in solar array elements failure over time in a spacecraft and reducing battery charging capacity.

A solar outage or sun outage refers to the condition where excessive radiation from the Sun interferes with satellite radio communication. This can occur, for example, when the excessive radiation from the sun affects the receiving capabilities of one or more ground stations, one or more satellites, or one or more space stations, according to the positions of the sun and the affected device. For example, the sun may be positioned in a manner where its radiation increases the noise temperature of a ground station's receiving antenna. The noise temperature increase in the ground station's receiving antenna causes a degradation of gain/system noise temperature (G/T). The degradation of G/T causes the ground station to have poor reception or no reception at all. For example, a high G/T value for a receiving antenna means the ground station can receive weaker signals more effectively, as the antenna has high gain and low noise temperature. This ultimately leads to better signal quality and improved communication reliability. A low G/T value can indicate poor reception capability, either due to low antenna gain, high system noise (such as from solar radiation), or both.

Accordingly, the IRCS 102 can monitor the predictable nature of the Sun movement and estimate when a solar outage will occur. Based on an upcoming solar outage, the IRCS 102 can take necessary actions to reroute communications to the Internet host to avoid potential disruptions. In this manner, the IRCS 102 can prevent disruptions in communications even when faced with solar outages and other potential outages. This process will be further described below.

During 112, the IRCS 102 can obtain or monitor locational positions of the devices in system 100. In further detail, the IRCS 102 can obtain current locational positions of the client devices 138, the ground stations 136, the LEO satellites 140, the GEO satellites 142, and the space hosts 144. The locational positions can include for example, three dimensional coordinates for each of these devices, such as latitude, longitude, and altitude coordinates. In some implementations, the IRCS 102 can obtain a current trajectory for the various devices that move. For example, the IRCS 102 can obtain trajectories for the LEO satellites 140, the GEO satellites 142, the space hosts 144, and the client devices 138. The IRCS 102 can obtain trajectories of client devices 138 if the client devices 138 are located in an orbit, such as a LEO orbit, a GEO orbit, or a MEO orbit.

In some implementations, the IRCS 102 may retrieve the location positions of the devices in system 100 from a set of databases. The system 100 can include a database for satellite locations 104, a database for Earth stations 106, a database for client locations 108, and a database for ephemeris data 110. Each of these databases can store locational information for respective devices along with timestamp information recorded locations. The database for satellite locations 104, for example, can store locations of each of the satellites in system 100 and a time at which the locations were collected. The database for earth stations 106, for example, can store geographical locations, e.g., longitude and latitude, for the ground stations 114 on the Earth and a time at which the locations were collected. The database for client locations 108, for example, can store geographical location for each of the client devices and a time at which the locations were collected. The database for client locations 108 may also store altitude data, along with latitude and longitude data, if a particular client device is located in satellite orbit. The database for ephemeris data 110 can store position and velocity of the satellites and the space hosts and a time at which the position and velocity was collected. The position and velocity of the satellites and the space hosts can be collected at regular intervals, e.g., 1-minute intervals.

Here, the IRCS 102 can poll or obtain information from each of these databases to generate routing tables for each of the devices in system 100. As will be further described below, depending on the current situation of system 100, the IRCS 102 can generate routing tables to provide to each respective device. The routing tables can include, for example, segment routing version 6 (SRv6) segment ID (SID) lists for each respective device. The SRv6 SID list may include one or more IP addresses that each device uses for communicating with other devices in system 100. The IP addresses can correspond to the devices shown in system 100. The devices can inspect the SRv6 SID lists to determine a next destination or hop for transmitting data.

In some implementations, the ground station 136-1, which has an IP address of 123.123.124.2, stores a routing table 134-N of 123.145.111.2 and 124.101.1.2. The routing table 134-N tells the ground station 136-1 that the next hop for routing communications is the LEO satellite 140-2, which has an IP address of 123.145.111.2. The second IP address in the routing table 134-N tells the ground station 136-1 that the final destination for routing communication is 124.101.1.2, which corresponds to the space host 144-1. In some implementations, the ground station 136-2 includes a similar routing table 134-3 as the routing table 134-N.

In some implementations, the client device 138 includes a routing table 134-4 of 123.123.124.1, 123.145.111.2, and 124.101.1.2. The routing table 134-4 tells the client device 138 that the first hop in communications is to the ground station 136-2 (with an IP address of 123.123.124.1), the second hop in communications is to the LEO satellite 140-2 (with an IP address of 123.145.111.2), and the third hop in communications is to the space host 144-1 (with an IP address of 124.101.1.2.).

In some implementations, the space client includes a routing table of 134-1 of 123.145.111.2 and 123.123.124.2. The routing table 134-1 tells the space client 144-2 that the first hop in communications is to the LEO satellite 140-2 (with an IP address of 123.145.111.2) and the second hop in communications is to the ground station 136-1 (with an IP address of 123.123.124.2). Other examples are also possible.

In some implementations, the IRCS 102 can provide these routing tables to each of the devices in system 100 on an iterative basis. For example, the devices in system 100 are edge devices that utilize SRv6 routing information. In further detail, the IRCS 102 can provide the routing tables to each of the devices periodically, e.g., every 5 minutes, every 10 minutes, or other. In some implementations, the IRCS 102 can provide the routing tables each time a change occurs in the network.

Using the obtained data polled from each of the databases, the IRCS 102 can iteratively check whether various conditions are met. At 114, the IRCS 102 can determine whether a satellite communication path is breaking. At 116, the IRCS 102 can determine proactively or predict ahead of time whether a solar outage is upcoming for each client device and ground station, respectively. At 118, the IRCS 102 can obtain a battery state of charge of each Internet host in space. And, at 120, the IRCS 102 can detect network conditions across the devices shown in system 100.

For example, if the IRCS 102 detects communication in a satellite network breaking in 114, e.g., such as the GEO satellite 142-2 breaking connection with LEO satellite 140-2, then the IRCS 102 can generate new routing tables and transmit the routing tables to each of the devices. In another example, in 120, if the IRCS 102 detects network connections failing between a space host 144-1 and the LEO satellite 140-2, then in 126, the IRCS 102 may create a new communication path that routes traffic directly from the space host 144-1 to the ground station 136-2 and bypasses the LEO satellite 140-2. In 130 and 132, the IRCS 102 can generate new routing tables and transmit the routing tables to each of the devices for the updated communication path.

At 130, the IRCS 102 can generate a routing table for each device to access an Internet host. In further detail, the IRCS 102 can iterate through each of the devices and their corresponding communication links to determine whether to add IP address associated with devices as hops to reach the Internet host to the routing table. In particular, the IRCS 102 can iterate through each client device, each ground station, and each satellite, and their corresponding links to determine whether a communication link exists. For example, the IRCS 102 can iterate through each client device, and determine whether a communication path exists to an Internet host from each client device to the Internet host without or with at least one of a ground station and to each satellite. If a communication path exists, then the IRCS 102 can add the IP address for the ground station and/or the IP address to the routing table of the client device. Similarly, the IRCS 102 can iterate through each ground station and each satellite and determine whether a communication path exists to an Internet host. The IRCS 102 may determine, for example, that a communication path exists from a ground station 136-2, to the LEO satellite 140-2, and to the space host 144-1. In some implementations, the IRCS 102 may determine, for example, that a communication path exists from a ground station 136-1 to the space host 144-1. In response, the IRCS 102 can generate a routing table, for each device, which includes one or more IP address instructing how that device can route communications to the Internet host.

In 132, the IRCS 102 can transmit the routing tables to each of the corresponding devices. In further detail, the IRCS 102 can transmit the routing tables to each of the corresponding devices over a network, e.g., terrestrial network and/or satellite network.

After transmitting the routing tables to each of the devices, the IRCS 102 returns to monitoring the location and trajectory of devices in 112. The process from 112 to 132 repeats on an iterative basis. As the devices in the system 100 continue to move, the IRCS 102 needs to continuously monitor these devices for any potential issues that can disrupt communications. In this manner, the IRCS 102 can anticipate potential issues and in response, intelligently reroute communications prior to the potential issue occurring to ensure communications continue to resume seamlessly. For example, the IRCS 102 can predict potential issues ahead of time, e.g., sun outages and constellation routing access, and can change routing or DNS provisioning ahead of time. Accordingly, the IRCS 102 can predict or detect issues in the future, rather than reacting to issues that occur. On the other hand, if the IRCS 102 obtains real-time information about ISL failures, gateway failures, or terrestrial link failures, then the IRCS 102 can react to those problems and change routing tables for the present situation.

In some implementations, a client device can be located in a space station and the Internet host can be located on Earth. For example, the space client 144-2 is a space station that includes a client device, and the Internet host can be connected over a network to ground station 136-1. In this instance, the space client 144-2 can either communicate with the ground station 136-1 through a LEO satellite, e.g., LEO satellite 140-1, or the space client 144-2 can directly communicate with the ground station 136-1. In response to the ground station 136-1 receiving communications from the space client 144-2, the ground station 136-1 can forward the communications to the Internet host through one or more terrestrial networks.

In some cases, depending on the orbit the space client 144-2 is located, the IRCS 102 can instruct the space client 144-2 to route communications to the ground station 136-1 accordingly. In some implementations, if the space client 144-2 is in a GEO orbit, the space client 144-2 may directly access the ground station 136-1 to reach the Internet host. In some implementations, if the space client 144-2 is in a GEO orbit, the space client 144-2 may access a LEO satellite, such as LEO satellite 140-1, which subsequently transmits the communications to the ground station 136-1. In this manner, the space client 144-1 can take different routes to access the Internet host on the ground.

In some implementations, a space client 144-1 may require communicating with one or more other GEO satellites before reaching the ground station 136-1. This situation may occur under various circumstances. For example, if there is a solar outage when the sun, space client, and the ground station of the client align in the same line. In this case, a GEO satellite may be required as an intermediate hop or a satellite router to have communication with the ground station 136-1. As another example, if the line of site between the space client 144-1 and the ground station 136-1 is blocked or the link has poor reception, then another GEO satellite, such as GEO satellite 142-1, may be required as the intermediate hop to communicate with the ground station 136-1.

In the example of FIG. 1, the default next hop route in the routing table of space client 144-1 in GEO orbit is the ground station 136-1. However, due to the connectivity issues, e.g., the solar outage, the space client 144-1 would need to send communications to another GEO satellite, such as GEO satellite 142-1, before the communications are sent to the ground station 136-1. Accordingly, the IRCS 102 can intelligently determine routing information propagation. In some cases, the IRCS 102 can be located on Earth. In some cases, the IRCS 102 can be located on a space station, such as in LEO orbit or GEO orbit. The IRCS 102 can generate routing tables to provide to each of the devices in the system 100. The IRCS 102 may utilize border gateway protocol (BGP) routing protocols for transmitting data between devices in the system 100. In some implementations, the IRCS 102 may utilize software defined network (SDN) based SRv6 segment routing for generating routing tables for the devices in system 100.

Regardless of which methods the IRCS 102 uses for routing, in 116, the IRCS 102 can predict a solar outage for one or more devices in the system 100. The IRCS 102 can predict a solar outage using data provided by the databases, and movement information associated with the sun. Prior to the solar outage occurring, the IRCS 102 can perform various actions to ensure communications are not disrupted. For instance, the IRCS 102 can calculate an amount of time for the solar outage and the duration of such solar outage for each combination of space client and ground station. This can include, for example, a 5-minute solar outage for space client 144-2 and ground station 136-1 and a 3-minute solar outage for space client 144-2 and ground station 136-2, to name some examples. In order to take variations into account, the IRCS 102 can periodically evaluate the next solar outage time.

Next, prior to the predicted solar outage, the IRCS 102 can evaluate which of the GEO satellites can be used as a router for the space client 144-2 and the ground station 136-1 during the solar outage. At 122, the IRCS 102 may determine that GEO satellite 142-1 or another GEO satellite may be used to route communications from space client 144-2 to ground station 136-1. Then, prior to the predicted solar outage, e.g., a few minutes before the predicted solar outage, at 130, the IRCS 102 can generate a routing table to provide to the devices in 100 for rerouting traffic. For example, the IRCS 102 can generate a routing table to provide to the space client 144-1 that causes the space client 144-1 to route traffic to the GEO satellite 142-1. The IRCS 102 can generate another routing table to provide to the GEO satellite 142-1 that causes the GEO satellite 142-1 to route traffic received from the space client 144-1 to the ground station 136-1. At 132, the IRCS 102 transmits the generated routing tables to the respective recipients, e.g., space client 144-2, GEO satellite 142-1, etc. The routing tables indicate to the space client 144-1 that a particular GEO satellite, e.g., GEO satellite 142-1, as the next hop router for data to be transmitted to the ground station 136-1.

In response to the IRCS 102 transmitting the routing table to the devices in system 100, the space client 144-2 analyzes the routing table to determine the next hop for transmission and establishes the optical link with the device on the next hop. For example, the space client 144-2 establishes an optical link with the GEO satellite 142-1. Then, during the solar outage, the space client 144-2 transmits traffic for the ground station 136-1 through the GEO satellite 142-1. Additionally, in the uplink direction, e.g., from the ground station 136-1 to the space client 144-2, the ground station 136-1 may send communications directly to the space client 144-2 or through the GEO satellite 142-1.

In some implementations, a client device on the ground may desire to access an Internet host or server also on the ground. In such cases, it may be beneficial for the IRCS 102 to route traffic between the client device and Internet host both located on the ground through one or more LEO satellites in constellation fully or partially. The partial routing through the space refers to the case where traffic flows through both the terrestrial network and a satellite network in space, e.g., hybrid routing, between the ground client device and the Internet host on the ground.

The IRCS 102 may perform hybrid routing for a variety of reasons. These reasons may include, for example, terrestrial network congestion, network disaster that incapacitates the terrestrial link between a client device and the Internet host on the ground, and high latency on the terrestrial network, to name a few examples. The IRCS 102 may enable both terrestrial network and space network communications in various configurations like for diversity or increasing effective throughput. Similarly, the IRCS 102 may use a multi-path transport control protocol (TCP).

In some examples, the IRCS 102 may instruct the devices in system 100 to communicate in a hybrid environment using both terrestrial and space satellite routing between a client device and an Internet host located on the ground. For the system 100 to offer hybrid routing, the neighboring LEO satellites in system 100 can communicate using Inter-Satellite Link (ISL) using optical communication. ISL is a radio optical link between neighboring satellites.

For example, as illustrated in system 100, the IRCS 102 can instruct the client device 138 that the immediate next hop is the LEO satellite 140-2. However, the client device 138 can communicate with LEO satellite 140-2 through the ground station 136-2 acting as a relay if the client device 138 is unable to interface with the LEO satellite 140-2 directly. Afterwards, the LEO satellite 140-2 can transmit communications received from the client device 138 to one or more LEO satellites. The egress LEO satellite, e.g., LEO satellite 140-1 in the example of system 100, can connect to the ground station 136-1 that is nearest to the Internet host on the ground. A terrestrial link exists between the ground station 136-1 and the Internet host. In this manner, the communications travel from the client device 138 to the LEO satellite 140-2. The LEO satellite 140-2 transmits the communications to the LEO satellite 140-1. In response, the LEO satellite 140-1 transmits the communications to the ground station 136-1, which subsequently transmits the communications to the Internet host. In some cases, the various Internet hosts can bidirectionally communicate with the IRCS 102 along a similar path to which it received communications or along a different path, e.g., using routing tables pushed by the IRCS 102 or using its own stored routing information.

In some examples, the traffic between the client device and the Internet host can traverse both the terrestrial network and the space network satellites. However, the traffic travels in one direction at a time. The bi-directional communications are required when neither terrestrial networks nor LEO constellations can be used fully to connect to the client device to the host network. This is typically the case where ISL does not exist in some parts of the satellite routes, some parts of the terrestrial network are highly congested, or is down.

In some examples, the IRCS 102 can provide routing instructions for simultaneous use of both terrestrial networks and routing networks in a diversity configuration or an increased throughput configuration. In a diversity configuration, the same data stream is routed through both the terrestrial and space network. In an increased throughput configuration, the transmitting device divides the data stream between two communication paths and the device at the receiving end combines the divided data stream intelligently.

Thus, the IRCS 102 generates routing tables and propagates the routing tables to various devices in system 100 that include hybrid route planning. Moreover, when a traditional routing is in place, because of continuous motion of LEO satellites, the IRCS 102 needs to be involved to track the topology of the communications and triggers new route distributions through the system by propagating new routing tables to the various devices in system 100.

In some implementations, a client device located on the ground may seek to access an Internet host located in space. For example, client device 138 located on the Earth may seek to access an Internet host located at space host 144-1. This case may be involved with more than propagating routing tables because hosting a server, e.g., Internet host, in space, also requires consideration of power availability. Here, the IRCS 102 may determine routing to vary based on aspects specific to the space system as compared to the ground system.

In some cases, the Internet host located in space may be located in a GEO orbit, a LEO orbit, or a MEO orbit. In the example of system 100, the Internet host is located in a GEO orbit. The system complexity including routing is low when the Internet host is located in a GEO orbit because the Internet host on the space host 144-1 is generally stationary with respect to the Earth. When the Internet host is in a GEO orbit, a direct access from a client device on the ground would mostly be the cause because of the Internet host station being seen from a large part of the Earth. In some cases, such as during a sun outage, the IRCS 102 requires that a particular client device to connect to a GEO or LEO satellite and through that GEO satellite or a series of LEO satellites, the client device can reach the space host 144-1. Accordingly, the complexity is less when accessed through a GEO satellite.

In some example, the Internet host can be located in other orbits than an Earth orbit, such as a solar orbit. In this scenario, the Internet host can be located on a space telescope, which may provide Internet accessible service. Similar, the Internet host could be applicable to future lunar orbiting systems.

However, due to motion of the LEO satellites, routing complexity increases if communications pass through LEO constellations. For instance, accessing the space host 144-1 through the LEO constellations is required when small devices cannot directly access the space host 144-1 in GEO orbit due to low power availability in client devices, but these devices can close the link by using LEO satellites.

For example, if a client device 138 has satellite interface capabilities, the client device 138 can directly access a GEO satellite, e.g., GEO satellite 142-1, via which it reaches the space host 144-1 not accessible directly. A ground station, e.g., ground station 136-2, or relay may be utilized to connect to the GEO satellite 142-1 when the client device 138 is not capable of satellite communication or not powerful enough to close the link with the GEO satellite 142-1.

In some implementations, the client device 138 is capable of closing a communication link with only a LEO orbit or the space host 144-1 is not directly accessible. Accordingly, the IRCS 102 can instruct the client device 130 to connect to a LEO satellite 140-2 in view, and then routing occurs through a LEO constellation, e.g., one more LEO satellites, before an egress LEO satellite connects with the space host 144-1. In the case where the client device 138 does not have a satellite interface or cannot view any LEO satellite, the client device 138 can utilize ground station 136-2 or relay which connects to a LEO satellite, such as LEO satellite 140-2. Depending on the location of the space host 144-1, the IRCS 102 may instruct the ground station 136-2 to transmit communications to another ground station, e.g., ground station 136-1, through the terrestrial network, which has better visibility and connectivity with the space host 144-1.

In some cases, the space host 144-1 may be located in a LEO orbit. In this case, the IRCS 102 would need to instruct client 138 to route communications from LEO satellites for a client to access with the space host 144-1 in the LEO orbit. Accordingly, the IRCS 102 may instruct the various devices in system 100 to communicate using hybrid routing through one or more other LEO satellites and a terrestrial network.

In some implementations, the IRCS 102 may deploy communications where the space host 144-1 is located in LEO orbit and is accessed directly by a client device 138 or via a relay on the Earth. In some cases, depending on the location of the space host 144-1, the IRCS 102 can determine a communication pathway to the space host 144-1 in LEO orbit utilizing routing through a terrestrial network. In this example, when the space host is in LEO orbit and the space host is accessed from a client device on the ground, the IRCS 102 may require routing communications through one or more LEO satellites. This may be a complex scenario because both the space host 144-1 in the LEO orbit and the LEO satellite routers are in constant motion around the Earth.

In this case, the IRCS 102 can analyze the power aspect and solar outage, for example, of the Internet host in space. As mentioned, the availability of power to operate Internet hoists in space can vary over time and in a predictable manner. The predictable characteristics can include, for example, sun interference variability, changes in the route to access an Internet host in space, the orbital motion the space host in LEO or MEO orbit around the Earth, and access delay variation. Any satellite constellations, whether GEO or LEO all experience, predicted eclipse and regular shadowing of the Sun. This may also occur to a spacecraft. Therefore, there may be a challenge in managing power during these occurrences for any space-based Internet hosts.

During these periods of shadows, solar charging ability for the Internet-based host is lost, and batteries drain at a much faster pace. Thus, in order to prevent draining of batteries during an eclipse or regular sun shadowing, the space host is required to reduce the number of services to preserve battery life. Here, the space host reduces the number of services by only selectively processing traffic to the space host based on criteria. The criteria can include, for example, traffic priorities or to halt host services completely for periods of time until a sufficient amount of battery charging is obtained.

In order to address this capability, the space host can exploit the fact, a priori, that lower or high-power periods will occur. The space host can determine when lower or higher periods will occur, either by obtaining metrics from the on-board power system or from a ground system as part of satellite tracking, telemetry, and command system (TT&C). Such advanced knowledge is not typically applied to terrestrial hosts and is therefore unique to space-based hosts.

In some implementations, the IRCS 102 can perform domain name service (DNS) management for the space host that is affected by a predicted solar outage or when the battery charge drops below a threshold. In further detail, the IRCS 102 can use a mechanism in the DNS protocol known as DNS Time to Live (TTL). DNS TTL is a setting (e.g., a value in a designated field of DNS records) that tells the DNS name resolver an amount of time to cache a DNS records before requesting a new query. The DNS name resolver may be located on the ground or in space. For example, if the DNS TTL is set to 600 seconds (10 minutes), the resolver will have to regather the details for a particular website, e.g., a website for the space host, every 10 minutes. If 500 users visit the website for the space host during that time period, the 500 users will each see the same thing on the website until the DNS TTL refreshes after 10 minutes.

In further detail, a value of the DNS TTL is represented in time. When the DNS TTL expires or elapses, the DNS resolvers, such as a local DNS system, can contact an authoritative DNS server to refresh a DNS cache so that any change in the IP address of the host can be reflected in the resolver's cache. The IP address of the Internet host changes in order to prevent user devices or clients on the ground from accessing that specific Internet host during its low power period, eclipse period, or shadowing period. In some implementations, the IP address of the Internet host may resolve to another IP address that is associated with a different Internet host in a federated configuration. The federated configuration will be further described below. For example, the IRCS 102 can intelligently set the value of the DNS TTL associated with the Internet host based on predictions of anticipated timing of such events, e.g., battery charge of host drops below threshold, occurrence of predicted eclipse, or projection of Internet host power draining rate. This is different from standard systems where a consistent generic time is used without regard for such events.

For instance, the IRCS 102 can, in advance of one of the aforementioned issues, shorten an amount of time for the DNS TTL such that the DNS TTL expires at the occurrence or start of one of the previously mentioned conditions. For example, the IRCS 102 can determine that the predicted eclipse is expected to occur in 5 minutes for a particular client device and a ground station. In response, the IRCS 102 can adjust a DNS TTL value of the Internet host in space to 5 minutes, such that the DNS TTL expires at the occurrence of the predicted eclipse. Then, when the DNS TTL value of the Internet host in space expires, the local DNS requests from the authoritative name server to resolve the name of the Internet host to an IP address. In this case, the authoritative name server operates by not resolving a name to an IP address due to the current predicted eclipse occurring or that the authoritative name server resolves to an IP address that is associated with a different Internet host in space. The authoritative name server operating in this manner will prevent user devices or client devices on the ground to accessing Internet hosts in space during its low powered battery period, eclipse period, or shadowing event period. Once the Internet host comes out from the low power condition or moves to the sun availability period, the access to the Internet host is restored by changing the DNS TTL value. In some cases, the IRCS 102 can change the DNS TTL value in advance because of the fact that a duration of an eclipse is highly predictable.

In some implementations, the IRCS 102 is configured with an eclipse profile. The eclipse profile enables the IRCS 102 to know precisely when a solar outage, e.g., an eclipse, will occur and the duration of the solar outage. During 118, the IRCS 102 can receive on a periodic basis a battery state of charge of the Internet host in space. If the system 100 includes multiple Internet hosts in space, then the IRCS 102 can receive a battery state of charge for each of the Internet hosts in space. In some cases, a space host in GEO orbit can directly report its battery state of charge to the IRCS 102 or via a GEO orbit satellite or a LEO orbit satellite acting as a relay router. Similarly, a space host in LEO orbit can directly provide or report the battery state of charge to the IRCS 102, but that will not be the most use cases due to orbital motion. In some cases, the Internet host in LEO orbit can utilize a GEO orbit satellite, a LEO orbit satellite, or a series of LEO satellites, to communicate its battery state of charge report to the IRCS 102 on the ground.

During 124, the IRCS 102 can compare the value of the battery state of charge of the Internet host in space to a threshold value. For example, the value of the battery state of charge is 20% for a space host 144-1 and the threshold value is 50%. If the IRCS 102 determines that the value of the battery state of charge is less than the threshold value, e.g., does not satisfy, then the IRCS 102 performs DNS management. Otherwise, if the IRCS 102 determines that the value of the battery state of charge is equal to or greater than the threshold value, e.g., does satisfy, then the IRCS 102 performs a no-operation and returns back to 112.

In some examples, if the IRCS 102 determines that the battery state of charge does not satisfy the threshold value, then during 128, the IRCS 102 adjusts the DNS TTL value to prevent client access to the Internet host during the solar outage or while the battery state of charge is below the threshold. The process 128 is further explained throughout the description below.

In some implementations, a user device or client device on the ground can contact a local DNS to resolve the host name of the Internet host in space. The local DNS may typically be on the ground, or the client may implement a local DNS server or caching. Additionally, the host name of the Internet host in space may be, for example, www.spacehost.com. The system 100 performs the following processes for resolving the Internet host name, e.g., in space GEO or LEO orbit, to its IP address.

Initially, the local DNS or client device can check whether a local cache includes the IP address of www.spacehost.com. If yes, then the local DNS returns the cached information of the IP address to the client device. If not, then the local DNS transmits a resolution request to the authoritative DNS.

The authoritative DNS can resolve the domain name of www.spacehost.com. The domain name can point to or redirect to www.spacehost.examplesys.com, e.g., the CNAME record of the domain name. The CNAME can map www.spacehost.com to www.spacehost.examplesys.com to redirect the domain name request to the IRCS 102. Accordingly, the hostname of the IRCS 102 is www.spacehost.examplesys.com. Then, the local DNS redirects the request to the IRCS 102.

In some implementations, the IRCS performs smart domain resolution. In further detail, the IRCS 102 can provide the client or the name resolver with the IP address of the Internet host in space along with the corresponding DNS TTL value. As an example, the DNS TTL value is set to a 5-minute period. If there is a predicted eclipse coming soon, such as before the 5-minute TTL expiring time, the IRCS 102 sets the DNS TTL value to expire close to the start of the eclipse period. Similarly, if the battery state of charge is below a threshold at this moment, then the IRCS 102 sets the DNS TTL value to zero or an exceedingly small value. In some cases, the IRCS 102 may redirect the client to another Internet host in a federated setting using the CNAME construct mentioned above. The federated setting will be further mentioned below. Then, the client device's browser obtains the IP address of the Internet host in space and accesses the Internet host in space.

Thus, just before the start of an eclipse, the DNS TTL expires and the local DNS resolver either contacts the IRCS 102 directly or indirectly via the authoritative DNS server, e.g., using CNAME redirection, to resolve the host name of the Internet host in space. Since the IRCS 102 is aware of the predicted eclipse, the IRCS 102 either provides no IP address or a CNAME redirection to another host in a federated setting. This is the way access to the Internet host in space going through an eclipse can be avoided. The IRCS 102 can determine when an eclipse will be over and accordingly sets the DNS TTL value to get a DNS request right after the eclipse is over. At this time, when the eclipse is over, the IRCS 102 can provide the requesting client device with the IP address of the Internet host in space.

Similarly, upon expiration of the DNS TTL from a battery threshold point of view, the IRCS 102 blocks access to the Internet host in space. When the IRCS 102 determines the state of charge of battery for the Internet host in space has increased beyond a threshold, the IRCS 102 can provide the client device with a valid IP address of the Internet host in space. Also, during the eclipse period or a low battery below a threshold period, the IRCS 102 can reduce the DNS TTL period to a smaller value to ensure that the IRCS 102 receives a DNS request from the client device right after an eclipse is over or a low battery condition is removed.

In some implementations, the IRCS 102 may alternatively or additionally disable processing for an Internet host in space according to a progressive step-down or step-up algorithm based on predicted or reported power availability. The IRCS 102 may automatically tie connection request drops or service level requests to available processing or power. Here, the Internet host in space is not abruptly disabled or closed down. Rather, the connection requests are dropped in steps that are tied with power availability. For example, the number of requests the Internet hosts in space accepts from one or more client devices are progressively decreased following the step-down logic when power availability is decreasing and is progressively increased following the step up when power availability begins to increase. When the system reaches the last step downwards, the Internet host in space access is completely disabled.

In some implementations, the step up and step-down power availability-based controlling of volume requests scheme is built around a periodic message that the IRCS 102 receives from the Internet host in space containing the state of charge of battery information. For example, the Internet host may provide the state of charge of battery information to the IRCS 102. In another example, the IRCS 102 may receive information for each Internet host in space from a ground system. The information for each Internet host in space can include, for example, state of charge of battery information, ephemeris data, and equipment health information.

In some implementations, the number of requests that the Internet host in space may accept may vary according to the battery state of charge of the corresponding Internet host. For example, the IRCS 102 may set a threshold for the number of requests the Internet host can receive for a set unit of time. The threshold may be 1000 requests for the next one hour. After the threshold has been reached, the IRCS 102 may instruct the Internet host to perform one or more functions for those requests. For example, the IRCS 102 may instruct the Internet host to queue those requests to process until the battery state of charge exceeds a threshold time. In an example, the IRCS 102 may instruct the Internet host to process those requests at a slower rate than the IRCS 102 may otherwise process. In an example, the IRCS 102 may instruct the Internet host to reject those requests that exceed the threshold value.

For example, the IRCS 102 may dictate how many requests are to be permitted according to the state of charge of batteries. The IRCS 102 may dictate that no request is allowed to be sent to the Internet host in space or accepted by the Internet host in space when the battery state of charge is less than a first threshold value, e.g., 20%. Assuming that the battery state of charge begins to increase. If the battery state of charge is between the first threshold value, e.g., 20% and a second threshold value, e.g., 40%, then the Internet host in space may permit N number of requests. With a further increase in the battery state of charge, the following can request can be accepted. If the battery state of charge is between the second threshold value, e.g., 40% and a third threshold value, e.g., 60%, then the Internet host in space may permit 2*N number of requests. If the battery state of charge is between the third threshold value, e.g., 60% and a fourth threshold value, e.g., 80%, then the Internet host in space may permit 3*N number of requests. If the battery state of charge is between the fourth threshold value, e.g., 80% and a fifth threshold value, e.g., 100%, then the Internet host in space may permit 4*N number of requests. If the battery state of charge is equivalent to the fifth threshold value, e.g., 100%, then the Internet host in space may permit 5*N number of requests. In some cases, if the battery state of charge is equivalent to the fifth threshold value, then the Internet host in space may not put any restrictions on the number of requests it can receive.

In some cases, the step size and up/down thresholds can be configured in the IRCS 102 with respect to the predicted power availability. Accordingly, the Internet hosts actively perform admission control. Therefore, despite some of the requests not being processed by the Internet host in space, the requests are still viewed as leading to some power consumption by the Internet host in space. Hence, the Internet host in space dropping requests would be better than rejections in order to reduce the downlink/return path transmit power consumption of the Internet host in space.

The restricted admission control can be achieved by manipulating the DNS TTL and the DNS response from the IRCS 102. The IRCS 102, which hosts the DNS service also knows the state of charge of batteries of the Internet host in space because this information is continuously conveyed to the IRCS 102 from the Internet host. Accordingly, the IRCS 102 either fully stops DNS advertisement of the Internet host in space or selectively blocks access for some users depending on the batteries state of charge.

When the IRCS 102 determines that the battery state of charge of the Internet host in space is equivalent to 100%, the IRCS 102 resolves all DNS requests and continues to monitor the battery state of charge of the Internet host in space. While the battery state of charge of the Internet host in space drains or continues to decrease, the IRCS 102 can reduce or shorten the DNS TTL value of the Internet host in space. In this manner, the name resolver contacts the IRCS 102 more frequently and provides the IRCS 102 with more of a chance to control admission requests for access to the Internet host in space from clients depending on the battery state of charge. Accordingly, as the battery state of charge decreases, the IRCS 102 blocks more DNS requests. Then, when the battery state of charge for a respective Internet host in space reaches below 20%, for example, the IRCS 102 stops DNS advertisement for that Internet host in space, until the battery state of charge moves above 20%. The IRCS 102 can utilize partial blocking of DNS with various logic, such as first come first server manner. This means that the requests coming behind are blocked or the selective blocking is performed by a priority of clients.

From a routing aspect when an Internet host in space is located in the GEO orbit, the IRCS 102 likely does not vary the routing between the Internet host in space and a ground station. In some cases, based on the geographic location of the ground client, it is possible that the ground client cannot directly access the Internet host in space. This issue can be solved in a variety of manners.

First, if the ground station can view a particular GEO satellite, then the ground station can communicate with the space host through the particular GEO satellite as a relay. In this instance, the space host will create an optical communication link between the particular GEO satellite and the space host. The ground station can be configured with the information of the GEO satellite as an alternate path when it cannot access the space host directly. The space host, based on the fact that it receives traffic for a client via a GEO satellite, responds or sends replies and data to the client via the same GEO satellite.

Second, the client can communicate with the Internet host in space through a ground relay, e.g., which could be a ground station on Earth with a satellite gateway, with a terrestrial routing to reach the relay. In this instance, the relay has a view to the Internet host in space that enables the relay to communicate directly with the Internet host in space. This option may also be utilized when the ground station is not capable of satellite communication.

Third, the ground station can use one or more LEO satellites, e.g., LEO constellations, to communicate with an Internet host in space. For instance, the ground station can directly communicate with a LEO satellite in its view and then there is an optical communication link between the LEO satellite and the Internet host in space. Here, the LEO satellite is directly in contact with the ground station, known as an ingress LEO satellite, and may not be able to access the Internet host in space directly. Instead, the ingress LEO satellite routes communications through other LEO satellites using ISL links to reach the egress LEO satellite, which ultimately contacts the Internet host in space. Here, this option may also be used even if the ground station can have line-of-sight with the Internet host in space in GEO orbit but cannot close the link. Also, this option may be applicable when the client device does not have satellite interface, but where the ground station through terrestrial routing reaches a relay which contacts the ingress LEO satellite.

Continuing with the above options, the Internet host in space is located in the GEO orbit and is stationary from Earth. The Internet host in space can be accessed by an egress LEO satellite where the ingress LEO satellite may require one or more LEO satellites to reach the egress LEO. Although the Internet host in space is stationary relative to an Earth observer, the one or more LEO satellite routers including the ingress and egress LEO satellites are not fixed, and instead are moving continuously around the Earth.

In a traditional routing mode, the IRCS 102 continues to change the next hop egress LEO satellite for the Internet host in space as the current egress LEO satellite cannot access the Internet host in space any more due to its movement around the earth. The IRCS 102 assigns a new LEO satellite as the egress LEO satellite and the IRCS 102 provides updated routing tables to the devices in system 100. The client device, if equipped with satellite communication capability, selects a particular LEO satellite as the ingress LEO satellite. Then, the IRCS 102 distributes routing tables or SRv6 SID lists through a series of LEO satellites so that traffic flows between the ingress and egress LEO satellites. When the client device does not have any satellite in view or is not satellite communications capable, a ground station acts as a relay to contact the ingress LEO satellite. Additionally, a terrestrial routing is in place between the client device and the relay gateway. The IRCS 102 can select the relay gateway for the client device and the routing protocol ensures that the client device can reach the relay gateway.

Again, the traditional BGP routing protocol may not be efficient in a case of constantly moving LEO satellites around the Earth through which traffic flows. Therefore, a centralized controlled software defined network (SDN) routing protocol is more efficient here. As mentioned earlier, the IRCS 102 can function as an SDN controller which distributes SRv6 SID lists to the Internet host in space, the relay gateway, the ingress LEO satellite, or the client device if the client device is SRv6 capable. If the client device is SRv6 capable, this provides a path from the client device to the Internet host and from the space host to the client device. However, these paths can change continuously to track satellites' motion. Note that the client device may not be provided with any SID list if the client device is not able to process SRv6 protocols. In this case, the client device can use other software to process SID lists that may not be SRv6 related. The relay gateway and the space host can be provider edge (PE) entities. The ingress LEO satellite of a client is also a PE entity that enables the client device to directly access the LEO satellite. For example, the PE entity and the ingress LEO satellite can receive the SID list from the IRCS 102.

Like in the previous use case, there might be broken ISL links between satellites or the ISL link does not exist. In this case, the IRCS 102 can provide routing tables to perform hybrid routing. Here, for example, traffic from the last LEO satellite is redirected to a ground station and terrestrial routing makes traffic flow to the ground station from where traffic again moves to space. This means the SID list provided to the PE devices would have terrestrial nodes in it.

In addition to stopping DNS advertisements, the IRCS 102 can disable or stop routing protocol handshakes with (ground or space) routers with the Internet host during low availability of power so that battery is not drained out completely. This may otherwise require more time to charge battery of the Internet host when it is completely drained out and reduces overall lifetime of batteries.

In some implementations, the system 100 may include a federated host concept for an Internet host in space. The federated concept represents a decentralized model for Internet hosts or servers that breaks away from traditional monolithic systems to create an interconnected network of servers or hosts, where each host maintains a certain level of autonomy. The key characteristics of the federated host concept include, for example, decentralization, interoperability, scalability, and standardization. These characteristics present a number of key advantages over traditional monolithic architectures. Some of the benefits of utilizing the federated host concept include, for example, flexibility with agility, scalability, enhanced collaboration and data sharing, latency optimization, and improved fault tolerance and resiliency. Therefore, in the system 100, the deployment of federated architectures based in space with different Internet hosts can be provided.

In a federated architecture system, there may be multiple hosts that will support or provide a given application for processing. As mentioned earlier, the IRCS 102 can estimate and predict the occurrences of shadowing due to eclipses, sun outages, and route shifts due to orbital motion, to name some examples. In doing so, the IRCS 102 can use the knowledge of predictable sun outages, power reduction or low power conditions, or route changes to shift load among federated hosts in a controlled manner as required to keep up services and applications accessible during disruptive periods. The Internet hosts in federated architectures can coordinate among each other and ensure that some Internet hosts are available to make applications or services accessible to client devices, where these Internet hosts do not experience sun outage or low battery conditions.

The federated architecture system can utilize the combination of DNS mechanisms and CNAME constructs of the DNS service to achieve the above goals. For example, an entity on the ground or on a GEO satellite, such as the IRCS 102, is proposed to be working as a proxy to ultimately generate DNS replies received by the DNS resolver. The idea can be applied to cases when the CNAME record is used or not used by the IRCS 102.

The DNS response from the authoritative server can contain the CNAME of the IRCS so that the name resolver contacts the IRCS to resolve the name to an IP address. The IRCS 102 can return a list of ordered IP addresses that corresponding to multiple servers or Internet hosts in a federation. Here, the IRCS 102 can determine the condition and status of each host in the federated setup such as a battery power situation, a sun outage, and route shift. When there are no disruptions, e.g., no sun outages, no low power condition, or no route shift, the IRCS 102 can provide the list of IP addresses of the Internet hosts in a static mode or changes to list in a round robin fashion. The IRCS 102 can predict for each host in the federated cluster those attributes such as, for example, the sun outage, the route shifts due to orbital motion, and other. The IRCS 102 can receive the battery state of charge for all the hosts, such as from a ground system or from each corresponding Internet host, in a federated setting and determine a DNS TTL for each of the Internet hosts.

If the IRCS 102 detects a low power condition, sun outage, or eclipse, for a respective Internet host, the IRCS 102 can change the Internet host that will provide the service in a federated setting. For example, the IRCS 102 can take two actions. First, the IRCS 102 can change the order of the IP address list in the federated setting. The IRCS 102 can modify the list before replying to the DNS resolver so that the IP address of the newly selected Internet host is at the top of the list. The IRCS 102 can push the Internet host to the top of the list that is not experiencing any one of the aforementioned disruptions, e.g., low battery condition, any outages due to eclipse or shadowing, or other. However, if the IRCS 102 determines that the DNS TTL value has not expired for that newly selected Internet host, the DNS resolver or the client device will not request to resolve the domain to IP address for that Internet host. Additionally, the cache will not be refreshed. Therefore, based on the predicted outages, the IRCS 102 can adjust the DNS TTL such that the DNS TTL expires prior to the predicted change of the Internet host. Moreover, the resolver can then perform the DNS request from the IRCS 102 to obtain the appropriate IP address list.

In some cases, from a fixed ground station, different Internet hosts in a federated setting are visible at separate times of the day based on the orbital motion of those Internet hosts in space. The IRCS 102 can track the orbital motion of the Internet hosts and whether the ground station can view one or more of these Internet hosts. The IRCS 102 can intelligently set the DNS TTL values and can change the order of the federated hosts of the IP addresses accordingly so that the ground station can continuously change to different Internet hosts in response to the DNS TTL values expiring.

For instance, the process for accessing Internet hosts in a federated setting would work as follows. A client device can contact a local DNS, e.g., which may reside in memory of the client device, to reside the host name of Internet host in space. The hostname may be, for example. www.spacehost.com. The local DNS can check whether its cache includes the IP address of the hostname. If the cache includes the IP address, then the local DNS returns the cached information to the client device for use. If not, then the local DNS transmits a resolution request to the authoritative DNS.

The authoritative DNS can resolve the domain name. The domain name points to, for example, www.spacehost.examplesys.com (e.g., the CNAME record of the domain name). The CNAME can map www.spacehost.com to www.spacehost.examplesys.com, to redirect the domain name request to the IRCS 102. Then, the local DNS can redirect the domain name request to the IRCS 102.

The IRCS 102 can receive the domain name request from the local DNS resolver. In response, the IRCS 102 can perform intelligent domain resolution. In further detail, the IRCS 102 can provide the client device with an ordered list of IP addresses each corresponding to an Internet host in a federated setting along with the DNS TTL value for each IP address. If the IRCS 102 determines that a predicted solar outage is near for the Internet host corresponding to the first IP address in the ordered list, or if the IRCS 102 determines that the ground station is about to lose connection with the Internet host corresponding to the first IP address in the ordered list, then the IRCS 102 can set the DNS TTL value to expire close to the start of the disruption, e.g., the start of the eclipse, start of the sun outage, battery state of charge is below a threshold, or other.

In response, a browser of the client device transmits a DNS request because the DNS TTL has expired for the first IP address in the ordered list. The local name resolver contacts the IRCS 102 for the name resolution. Since the IRCS 102 determines that the federated host corresponding to the first IP address will be out of view to the client device due to one or more of the aforementioned disruptions, the IRCS 102 can change the order of the IP addresses by moving the first IP address in the ordered list to the bottom and placing a different Internet host from the federated list to the top.

In some cases, the IRCS 102 can intelligently select the different Internet host from the federated list to move to the top in terms of various criteria. For instance, the IRCS 102 can select which host in the list will be one or more disruptions the latest in time, among other options. In some instances, the IRCS 102 can apply a weight assigned to each criteria, such as a weight to eclipse, a weight to shadowing, a weight to low power, etc. The weight may be assigned a value based on a length of time the outage is to occur. For example, a higher weight may be assigned to a host that has a lower outage time or based on host processing capacity.

When the CNAME construct is utilized for the different host names in the reply from the IRCS 102, one domain name may point to different host names. For example, a domain name of www.spacehost.examplesys.com points to three different hosts, e.g., www1.spacehost.examplesys.com, www2.spacehost.examplesys.com, and www3.spacehost.examplesys.com. Other examples are also possible. The DNS server located at the IRCS 102 can provide this CNAME list, the order of which is intelligently chosen based on a predictive analysis by putting the Internet host on top which should be next accessed by the client devices at the given them. The DNS resolver can then request for IP addresses of the Internet host which is elected from the CNAME list. Additionally, the DNS TTL of the hostname, e.g., www.spacehost.examplesys.com, domain is adjusted in such a way that it expires at the time when a host is to be changed at the client device. In this case, when the DNS TTL expires, a resolver initiates a fresh request instead of serving the IP address response from a local cache.

The application-specific load allocation across multiple space-based platforms or hosts is proposed to address topology needs. The load allocation can include, for example, a space telescope application, where one host might be blocked by the Earth, and a look angle from doing a targeted image capture, and if another host is more capable of acquiring that image. The load allocation can also include, for example, latency to the ground or simple load capacity.

In some implementations, the communication between ground stations and inherent hosts may regularly experience access delay variation. For example, if an Internet host in space is in GEO orbit or if communications to the Internet host in space are reached using a GEO satellite router, another delay is added according to the number of delay hops. However, if the Internet host is located in LEO orbit or if the Internet host is being accessed via a LEO satellite, there may be an extra delay variation component added due to the orbital motion of LEO.

FIG. 1B is another block diagram that illustrates an example of a system 100 for intelligently routing communications in a hybrid communication network. FIG. 1B is similar to the block diagram components illustrated in FIG. 1A.

The system 100 illustrated in FIG. 1B illustrates devices and their communications. For instance, system 100 illustrates device in a ground-based network and a spaced-based network. The ground-based network can include, for example, a ground station 114-1, a terrestrial network 103, a client device 138-1, a client device 138-2, the Internet hosts 122, and the IRCS 102. The space-based network a space client device 120-3, a GEO satellite 120-1, and a LEO satellite 118-1.

In some cases, the Internet hosts 122, the local DNS system 127, and the authoritative DNS 129 can be located in either the space-based network or the ground-based network. Similarly, in some cases, the IRCS 102 can be located in either the space-based network or the ground-based network.

The system 100 of FIG. 1B illustrates one example of how the devices may communicate. For example, the IRCS 102 may communicate with the Internet hosts 122 and the client device 138-1 and 138-2 over a terrestrial network. In some cases, the IRCS 102 may communicate with the GEO satellite 120-1, the space client 120-3, and the LEO satellite 118-1 through the ground station 114-1. Here, the IRCS 102 may propagate the routing tables with the SID list to the respective devices in the space-based network through the ground station 114-1.

In some implementations, the local DNS system 127 can communicate with the authoritative DNS 129 and the IRCS 102. The local DNS system 127 may communicate with the authoritative DNS 129 to refresh a DNS cache in the client device 138-2. Similarly, the local DNS system 127 may communicate with the IRCS 102 to resolve a domain name, as will be further described below.

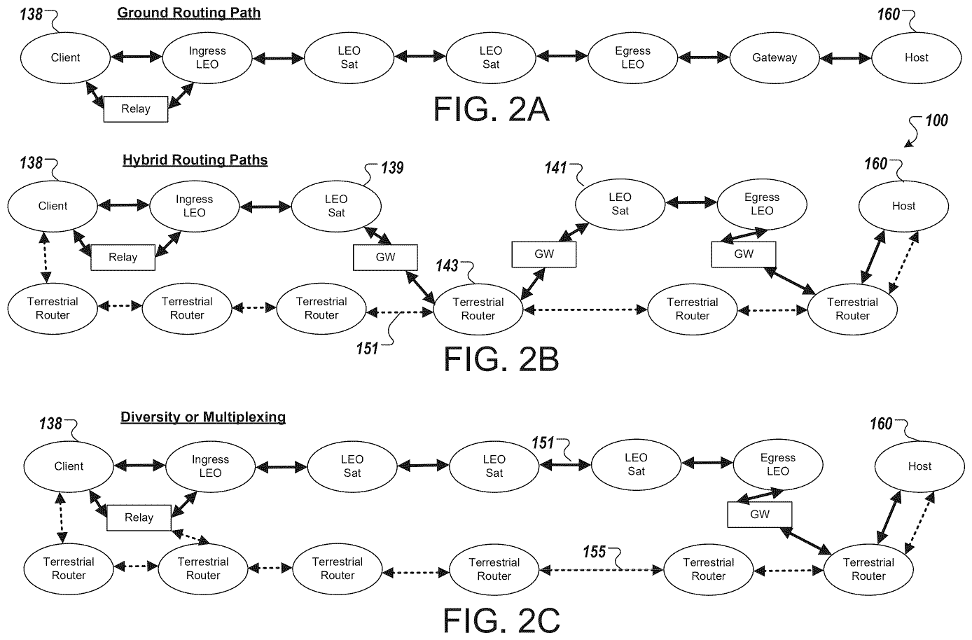

FIG. 2A is a flow diagram that illustrate an example of intelligently routing communications between a client device and a host on the ground using satellite networks. The flow diagram illustrates a ground routing communication path of devices shown in system 100.

In further detail, FIG. 2A illustrates an example of a complete path between a client device 138 and the Internet host 160, both of which are located on the Earth. If the client device 138 has LEO satellite interface capability, then the client device 138 contacts with the first or ingress LEO satellite in its view. If the client device 138 does not have LEO satellite interface capability, then the client device 138 communicates with the ingress LEO satellite using a relay, such as a ground station or other, that is satellite communication capable. The client device 138 transmits traffic to the ingress LEO satellite, which propagates the traffic through a series of LEO satellites over the ISL communication links until the egress LEO satellite is reached. The egress LEO satellite transmits the traffic over a downlink to a gateway, e.g., a ground station, which is connected to the Internet host via a terrestrial network.

In some implementations, the IRCS 102 can determine that at a given time, the terrestrial route between the client device 138 and the Internet host 160 is heavily congested, not available, or exceeds a latency threshold value. If the IRCS 102 determines that any of these conditions are met, then the IRCS 102 can decide to route traffic from the client device 138 to one or LEO satellite constellations, such as that shown in FIG. 2A. The IRCS 102 can propagate the routing table information, e.g., signaling to the client device 138 to route traffic through LEO satellites to the Internet host, to the client device 138 and other devices in system 100. The client device 138 receives the routing table information as a SID list, analyzes the routing table information to determine the next hop for transmission, and connects to the ingress LEO satellite either directly or through the relay.

In some implementations, the IRCS 102 can employ a traditional routing scheme to route traffic from the ingress LEO to the egress LEO satellite where the egress LEO satellite contacts a ground station satellite gateway nearest to the Internet host. However, due to continuous motion of the LEO satellite, the traditional routing scheme may require an exceedingly high time for routing convergence. In this case, the SDN based segment routing using SRv6 would be more beneficial instead of the traditional routing scheme. Here, the IRCS 102 can continuously and in real time or substantially real time, monitor the LEO satellites motion or trajectory in various orbits and orbital planes, and neighboring relationships between LEO satellites from the ephemeris data provided due to the highly predictable nature of the satellite movement. Accordingly, the IRCS 102 can generate and update the SRv6 SID list into the client or ingress LEO and the egress LEO satellites.

The IRCS 102 can select the egress LEO satellite based on the information about which of the ground station gateways is a correct choice to downlink data from the egress LEO satellite to the ground to ultimately reach the Internet host on the ground station. The IRCS 102 may select the egress LEO satellite according to various criteria, e.g., egress LEO satellite that is closest to the ground station that is connected to the Internet host, egress LEO satellite that has clearest line of sight to the ground station, among other criteria.

FIG. 2B is another flow diagram that illustrate an example of intelligently routing communications between a client device and a host on the ground using satellite networks. The flow diagram illustrates a ground routing communication path of devices shown in system 100.

In further detail, FIG. 2B illustrates another example of a complete path between client device 138 and the Internet host 160, both of which are located on the Earth. The dotted line path 151 from client device 138 to the Internet host 160 is one possible communication path for sending traffic through the terrestrial network. However, the IRCS 102 may learn of traffic congestion using a performance reporting interface, for example. For example, the traffic congestion is heavy traffic congestion, e.g., traffic congestion that satisfies a threshold value, in the dotted line path 151. In response to learning or detecting the heavy traffic congestion, the IRCS 102 can instruct the client device 138 to connect to the ingress LEO and communicate over the LEO satellites.

However, the IRCS 102 may determine that after traversing through some neighboring LEO satellites, there is no ISL link between the LEO satellite 139 and the LEO satellite 141. Accordingly, the IRCS 102 can instruct the LEO satellite 139 to connect to one of the nearest or viewable ground station, such as ground station 143. In response, the IRCS 102 can instruct the LEO satellite 139 to route traffic to the ground station 143 partly, and the IRCS 102 can instruct the ground station 143 to reach out to the next available or viewable LEO satellite, e.g., LEO satellite 141. Here, the LEO satellite 141 can forward traffic to the egress LEO satellite, e.g., directly or through a series of other LEO satellites, which subsequently forwards traffic on a downlink to the ground station. The ground station can forward traffic to the Internet host 160.

FIG. 2C is a flow diagram that illustrates an example of intelligently routing communications between a client device and a host on the ground using satellite networks. The flow diagram illustrates a ground routing communication path of devices shown in system 100.

In further detail, FIG. 2C illustrates an example of a complete path between a client device 138 and an Internet host 160, both of which are located on the Earth. FIG. 2C illustrates the scenario of multi-path routing for either diversity or increased throughput mode. In either of these modes, there exists both terrestrial and satellite communication paths from the client device 138 to the Internet host 160 substantially simultaneously, where through either of these paths, the client device 138 can exchange traffic with the Internet host 160.

In diverse mode of operations or configuration, the client device 138 and the Internet host 160 can transmit the same data stream through both paths, e.g., communication paths 151 and 155. The IRCS 102 can determine that both communication paths 151 and 155 are to be used. In this manner, the IRCS 102 configures the client device 138 and the Internet host 160 in a hybrid mode. Here, the client device 138 transmits traffic as its next hop to both the ingress LEO satellite and the ground station over the terrestrial network. The IRCS 102 can instruct the Internet host 150 to route traffic to both the satellite gateway and the terrestrial router. A complete one communication path 151 routing happens through a series of satellites and the other communication path 155 routing happens through the terrestrial network.

In some implementations, the IRCS 102 can decide to implement the increased throughput mode or multiplexing mode of configuration. In the increased throughput mode, the client device 138 divides a data stream into two substreams with one substream transmitted through the space network and the other substream is transmitted through the terrestrial network. The receiver at either the client device 138 or the Internet host 160 includes the capability to combine two streams received from two communication paths 151 and 155. The routing aspect other than determining from the ingress LEO satellites that a stream is divided remains the same as in the diversity case. Here, the IRCS 102 can instruct the ingress points, e.g., ingress LEO satellite, that traffic is to be sent between two paths by providing two next hop addresses or providing SID lists to the various devices.

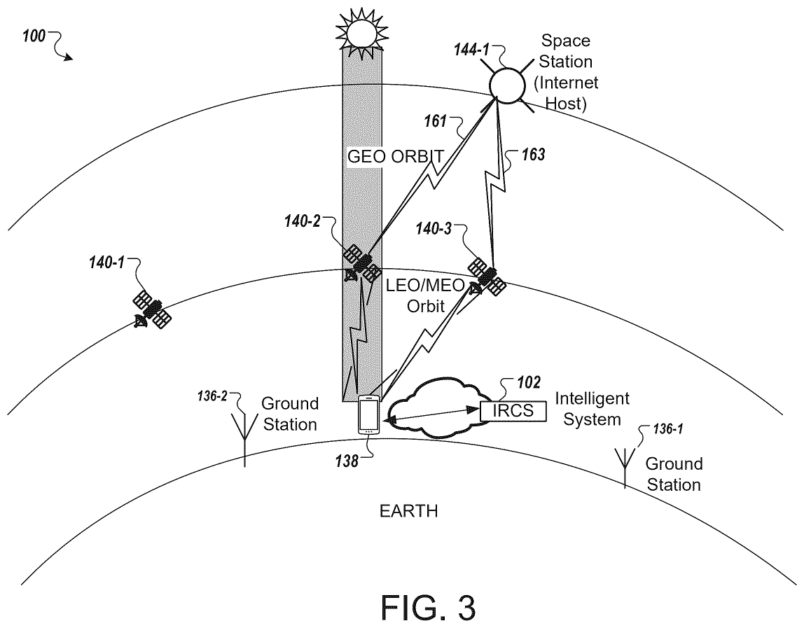

FIG. 3 is a block diagram that illustrates an example of system 100 for intelligently routing communications to an Internet host during a solar outage. The system 100 shown in FIG. 3 illustrates similar components and performs similar functions to those illustrated and described with respect to FIG. 1A.

In some implementations, the IRCS 102 can generate and provide new routing tables to the devices in system 100 during a solar outage and a low power condition. As mentioned, sun outage refers to the phenomenon where the excessive radiation from the sun causes interference in satellite radio communication. This can occur, for example, when the ground station, a satellite or space station, and the sun are all aligned in one line. In this instance, the sun is right behind the satellite causing noise temperature increase in the ground station receiving antenna. The noise temperature increase can create an overall degradation of G/T, which causes poor reception or no reception at the ground.

To avoid the solar or sun outage issue, the IRCS 102 can perform a split routing technique when the access to the Internet host 144-1 in GEO orbit is performed via one or more router LEO satellites. For example, as illustrated in FIG. 3, there are two LEO space router satellites, e.g., LEO satellite 140-2 and 140-3, where the LEO satellite under the sun outage, e.g., LEO satellite 140-2, is used to get to the Internet host 144-1 for uplink from the ground station 136-2 and another satellite not under the sun outage, e.g., LEO satellite 140-3, is used to reach a ground station 136-2 from the space Internet host 144-1. Alternatively, a different satellite router can be assigned to the ground station 136-2 for both the uplink and downlink if the current satellite router is under a sun outage from the ground station point of view accessing the Internet-based host. The IRCS 102 can predict each sun outage occurrence when parameters like satellite position and ground station position are known. Then, based on the IRCS 102 prediction, the split routing is activated by the IRCS 102. During the period of sun outage, adjacent routing handshakes can be performed to move over access through another satellite.

Prior to the solar outage event, the client device 138 on the ground had been accessing the Internet host 144-1 in space through a LEO satellite 140-2. Now, during the solar outage event, the LEO satellite 140-2, the sun, and the client device 138 are all aligned in one line, as illustrated in FIG. 3. The alignment of the sun, the LEO satellite 140-2, and the client device 138 causes a solar outage where the client device 138 and the LEO satellite 140-2 cannot communicate due to the sun negatively impacting the receive characteristics of these devices. However, the client device 138 continues to communicate with the LEO satellite 140-2 for its uplink transmission with the Internet host 144-1. The IRCS 102 is equipped with the precise knowledge of occurrences of all sun outages and according, the IRCS 102 is capable of changing the communication route to the Internet host 144-1. In further detail, the IRCS 102 can change the route to the Internet host 144-1 for the downlink transmission of traffic from the Internet host 144-1 to the client device.

FIG. 3 depicts a split route between the client device 138 and the Internet host 144-1 in space, e.g., a first transmission path 161 and a second transmission path 163. The client device 138 is equipped with multiple antennas, e.g., at least two antennae, to send transmission to and receive transmission from the Internet host 144-1 via two different LEO satellite routers, which are currently in view of the client device 138.

Prior to the solar outage, e.g., prior to the alignment of the sun, the LEO satellite 140-2, and the client device 138, the IRCS 102 can generate a new SID list for the Internet host 144-1. The new SID list can cause the Internet host 144-1 to route downlink transmission over the second communication path 163 and through the LEO satellite 140-3 to the client device 138. The IRCS 102 can propagate the new SID list to the Internet host 144-1. The Internet host 144-1 can set an optical communication link between the Internet host 144-1 and the LEO satellite 140-3. Now, the LEO satellite 140-3 can be used to communicate in both directions with the client device 138 and the Internet host 144-1. In some cases, the client device 138 may need to communicate through a relay gateway to the LEO satellite 140-3 if the client device 138 is not capable of communicating with the LEO satellite. In this case, the IRCS 102 can propagate a new SID list to the relay gateway in order to ensure the relay gateway forwards communications to the LEO gateway 140-3, instead of the LEO gateway 140-2.

In some cases, the client device 138 may access directly or through a ground relay the Internet host 144-1 in GEO orbit without requiring routing through a LEO satellite 140-2 or a LEO satellite 140-3. In this case, when the sun, the Internet host 144-1, and the client device 138 are aligned, a solar outage occurs. In some cases, if the client device communicates through the ground relay to the Internet host 144-1, then the solar outage occurs when the sun, the Internet host 144-1, and the ground relay are in alignment. If the Internet host 144-1 can be accessed through another GEO satellite that is not under the alignment with the sun, then downlink traffic can be routed through the other GEO satellite. In some cases, both uplink and downlink traffic can be rerouted through this new GEO satellite. The IRCS 102 can, prior to the solar outage, generate new SID lists for the Internet host 144-1, the client device 138, and the other GEO satellite. Then, the IRCS 102 can propagate the new SID lists to each of these devices so that communication can route through the new GEO satellite during the duration of the solar outage.

When the Internet host 144-1 is in GEO orbit and is accessed through one or more LEO satellites, the routing from the client device 138 continuously changes due to the movement of the LEO satellites around the Earth. The IRCS 102 continuously monitors the movement of the LEO satellites and provides SID lists accordingly to the client device 138, the Internet host 144-1, and the new LEO satellites to create new communication pathways. When one LEO satellite is out of view or unable to communicate with the client device 138 or the Internet host 144-1, the IRCS 102 can propagate a new SID list to another LEO satellite, the client device 138, and the Internet host 144-1 to create the new communication pathway. This process repeats as the LEO satellites continue to move around the Earth.

When the solar outage is over, the IRCS 102 can generate new SID lists for the Internet host 144-1 in GEO orbit, the client device 138, and the other GEO satellite. The new SID list instructs the Internet host 144-1 to communicate with the client device 138 directly or through the relay gateway. The new SID list for the other GEO satellite can revert communications to how the GEO satellite acted before the solar outage, e.g., moves back to the original configuration. The new SID list for the client device 138 can instruct the client device 138 to communicate directly with the Internet host 144-1 in GEO orbit or through the relay gateway.

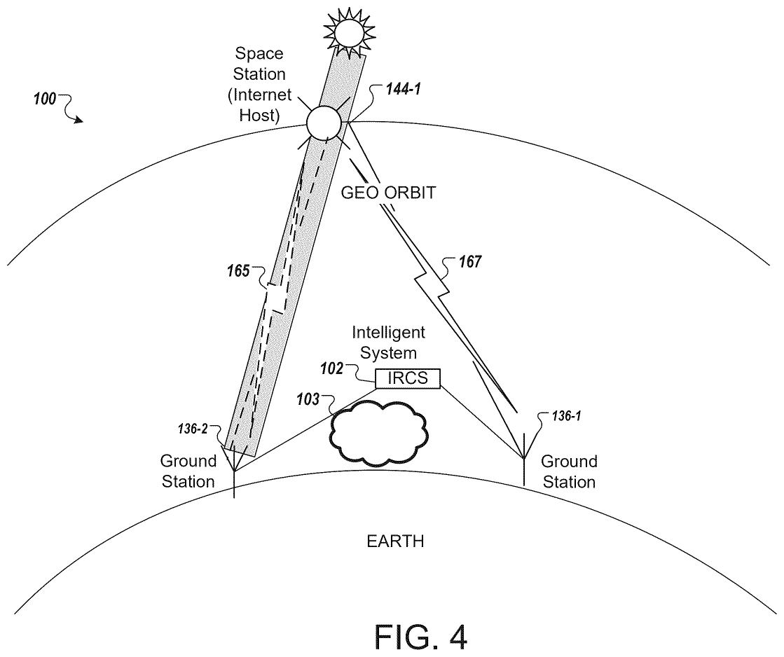

FIG. 4 is another block diagram that illustrates an example of system 100 for intelligently routing communications to an Internet host during a solar outage. The system 100 shown in FIG. 4 illustrates similar components and performs similar functions to those illustrated and described with respect to FIG. 1A.

In some implementations, the IRCS 102 can generate and provide new routing tables to the devices in system 100 during a solar outage. The new routing tables may create new communication pathways that are different from the communication pathways 161 and 163 created in FIG. 3. In further detail, there is another way to manage rerouting communications during a solar outage when Internet host 144-1 is in GEO orbit. The assumption is that the Internet host 144-1 can be accessible from more than one ground station locations through sufficiently different geometry such that only one of the ground stations will experience the solar outage at a given time. The solar outage can occur when the Internet host 144-1 and the ground station are in alignment. In the system 100, both ground stations will not simultaneously experience a sun outage. In this case, a ground station 136-1 will be clear of the solar outage when ground station 136-2 is aligned with the sun and in a solar outage.

Accordingly, since the IRCS 102 can predict the solar outage, the IRCS 102 can vary the routing table advertisement or SID lists to each of the ground stations 136-1 and 136-2 and to the Internet host 144-1 accordingly. For instance, prior to the solar outage of ground station 136-2, the IRCS 102 can generate and propagate SID lists to the Internet host 144-1 and the ground station 136-1 that cause communication to be rerouted from communication path 165 to communication path 167 during the solar outage. Similarly, if there is an upcoming solar outage of ground station 136-1, the IRCS 102 can generate and propagate SID lists to the Internet host 144-1 and the ground station 136-2 that cause communication to be rerouted from communication path 167 to communication path 165 during the solar outage.

For instance, during the solar outage of ground station 136-2, the ground station 136-2 will no longer as a relay for a client device 138 or the client device itself will not directly access the Internet host 144-1. Rather, the IRCS 102 can reroute traffic through the ground station 136-1 over the communication path 167, which is not under the solar outage, or any other ground station in the routing group connected with the ground station 136-2 to reach the Internet host. When the solar outage no longer takes place with the ground station 136-2, the IRCS 102 can determine the solar outage ends and create new SID lists so that the ground station 136-2 or the client device 138 will communicate directly with the Internet host 144-1 to reduce the access delay. In this case, there is no need to access the Internet host 144-1 through the other ground stations. The rerouting through other ground stations may cause further delays due to the geographical distance between the client device 138 and the other ground stations. The rerouting may also cause additional congestion and packet loss, which can be worsen the service for the client device 138.

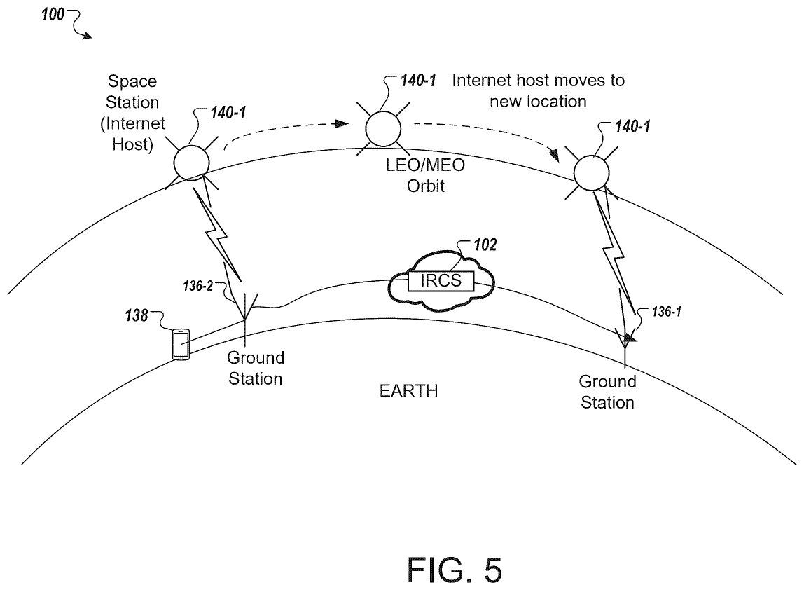

FIG. 5 is a block diagram that illustrates an example of a system 100 for intelligently routing communications over terrestrial networks when the Internet host is located in LEO orbit. The system 100 shown in FIG. 4 illustrates similar components and performs similar functions to those illustrated and described with respect to FIG. 1A.

In some implementations, the IRCS 102 can generate and provide new routing tables to the devices in system 100 when a client device 138 is unable to access an Internet host 140-1 in a LEO orbit. In this manner, the IRCS 102 can instruct the client device 138 to access the Internet host 140-1 in the LEO orbit the one or more other LEO satellites that as a routing space network. In this case, both the Internet host 140-1 and the LEO satellites actings as routers are constantly in motion. The movement of the Internet host 140-1 and the LEO satellites acting as routers may be in different orbits or different orbital planes. The continuous movement of the Internet host 140-1 and the LEO satellites as routers create for complex routing.

If the client device 138 includes built-in satellite communication capability, then the client device 138 can communicate directly with the Internet host 140-1 in various manners. In some cases, the client device 138 can directly access the Internet host 140-1 in space over a period of time when the Internet host 140-1 is in view of the client device 138. In some cases, the client device 138 may require communicating with the Internet host 140-1 through a series of LEO satellites to reach the Internet host 140-1 for a period of time. In this case, over time the series of LEO satellites will change because the Internet host 140-1 in LEO orbit is typically visible to a fixed region on Earth for a few minutes due to its movement around the Earth. In some cases, the client device 138 may not have any LEO satellites in its view to communicate with the Internet host 140-1. In this case, for the client device 138 to reach the ingress LEO, the client device 138 may communicate with a relay or gateway device using a terrestrial network. This is especially true if the client device 138 does not have satellite access capability. In this manner, the relay or the gateway device can either contact the Internet host 140-1 in LEO orbit or an ingress LEO satellite to reach the Internet host 140-1. In some cases, the client device 138 can access the Internet host 140-1 in space using a GEO satellite.

In some cases, the Internet hosts in LEO orbits can be accessed via one or more LEO satellites acting as satellite routers. In some cases, the Internet hosts in LEO orbits can be accessed directly from the ground. Here, the Internet host may be in view from different ground stations at separate times based on the location of the Internet host in the orbit. The Internet host can be viewed from different ground stations according to several factors that include, for example, the altitude of the Internet host from the Earth, the orbital plane of the Internet host, and the angular velocity of the Internet host as it orbits around the Earth. The IRCS 102 can determine the location of the Internet host in LEO orbit by using the altitude and the angular velocity of the Internet host. The IRCS 102 can obtain these several factors for monitoring the location of the Internet host in LEO orbit and for controlling the routing of communications to the Internet host accordingly.

In some implementations, the IRCS 102 can provide new routing tables to the devices in system 100 when the Internet host is located in a LEO orbit. The IRCS 102 can propagate the new routing tables in a quick and efficient fashion in order to maintain routing changes. This is especially the case when the Internet host is located in the LEO orbit because the Internet host moves at faster rate in the LEO orbit than in the GEO orbit. While the Internet host is in the LEO orbit, the IRCS 102 can generate and propagate new routing tables on a more frequent basis than when the Internet host in the GEO orbit.

In some implementations, the IRCS 102 can track the duration in which the Internet host in the LEO orbit is accessible to the client device 138. The client device 138 can access the Internet host in the LEO orbit while the Internet host is in view of the client device 138. When the Internet host in the LEO orbit is no longer in view of the client device 138, the client device 138 may lose contact to the Internet host. Then, the client device 138 would need to access through one or more LEO satellites acting as routers. However, the IRCS 102 can track this duration given the trajectory of the Internet host, the angular velocity, and its altitude, along with the geographical location of the client device 138.

Once the Internet host is no longer accessible to the client device 138, the IRCS 102 can determine which LEO satellites will be the ingress satellite for the client device. In response, the IRCS 102 can generate a SID list for the newly identified ingress satellite in order to reach the Internet host 140-1. If the client device 138 is capable of processing SRv6 SID lists, then the IRCS 102 can provide the SID list directly to the client device 138, where the next hop is the ingress satellite. Over time, the IRCS 102 can incorporate more LEO satellites to function as routers for routing communications from the client device 138 directly to the Internet host as the Internet host continues to move away from the view of the client device 138. Accordingly, the IRCS 102 can generate and provide the SID list to the Internet host, the new ingress LEO satellite, the other LEO satellites acting as routers, and the client device, for where the next hop for the Internet is the egress LEO satellite. The egress LEO satellite is the last satellite before reaching the Internet host 140-1.

As the Internet host 140-1 continues to move farther away from the client device 138, the IRCS 102 may involve more LEO satellites and ISLs. At a certain point in time, a maximum number of LEO satellites may be involved that enable communication from the client device 138 to the Internet host 140-1. After that point, the Internet host 140-1 may begin to move towards the view of the client device 138 because the Internet host 140-1 is orbiting around the Earth. At this point, the IRCS 102 may completely change the direction of the routing from the client device 138 to the Internet host 140-1 and with different LEO satellites. In this manner, the IRCS 102 can determine an angle at which the communications should change direction. The distance may be, for example, when the Internet host 140-1 is greater than 181 degrees from a point where the client device 138 is located on Earth. If the IRCS 102 determines the Internet host 141-1's location satisfies this threshold, e.g., is greater than 181 degrees, then the IRCS 102 can select a different direction for the communication from the client device 138 to the Internet host 140-1. Generally, the IRCS 102 can predict and track the changes of these devices in order to provide seamless routing table updates to the devices in system 100.

If there are any breaks in ISL links between LEO satellites, then the IRCS 102 can generate a routing table to propagate to these LEO satellites that causes the LEO satellites to connect via a terrestrial network or via another GEO satellite. In this case, the IRCS 102 can create the hybrid path concept, where a client device has a communication pathway to the Internet host 140-1 in the LEO orbit through the terrestrial network, as well as another communication path through one or more LEO satellites acting as routers.

As shown in FIG. 5, when the Internet host 140-1 is in the LEO orbit, the IRCS 102 can determine the correct ground station for a client device to route traffic through to reach the Internet host 140-1. The IRCS 102 can determine the correct ground station to communicate with the Internet host 140-1 due to the predictable nature of the movement of the Internet host 140-1, the location of the ground stations, and the location of the client device 138. Accordingly, the IRCS 102 can determine ground station 136-1 is to be used for communicating with the Internet host 140-1, can generate routing tables for each of the devices, and propagate the generated routing tables.

Moreover, the IRCS 102's advertisement of routing tables towards the Internet host 140-1 may vary based on the predictable location of the Internet host in LEO orbit. As the Internet host 140-1 moves in the LEO orbit, the ground station that the Internet host 140-1 communicates with can continuously change, e.g., change from ground station 136-2 to ground station 136-1 as the Internet host 140-1 moves. In some cases, the IRCS 102 can rely on traditional routing protocols or a software defined networking controller for predicted routing changes that may be located on the ground.

For instance, at one time instance, the Internet host 140-1 in LEO orbit has ground station 136-2 in its view. However, after a few minutes or another time period elapses, the Internet host 140-1 is no longer in coverage with the ground station 136-2. The system 100 is deployed in such a way that when the ground station 136-2 loses contact with the Internet host 140-1 another ground station, e.g., ground station 136-1 will be in contact with the Internet host 140-1. The client device 138 that is near and connected to the ground station 136-2 would need to route communications from the ground station 136-2 to the ground station 136-1 in a different geographical location. The IRCS 102 can make this determination, generate SID lists that causes the communications to be routed from the ground station 136-2 to the ground station 136-1, and can propagate these SID lists to each of the devices in system 100.

The IRCS 102 monitors and tracks the motion of the Internet host 140-1. When the Internet host 140-1 is about to lose contact with ground station 136-2, the IRCS 10-2 can determine the next ground station that will be seen by the Internet host 140-1 by consulting the Internet host motion data. Here, the IRCS 102 can determine, based on the motion data of the Internet host 140-1, the next ground station that the Internet host 140-1 is to be in view of is ground station 136-1 and provides updated SID lists to these devices, accordingly. However, the IRCS 102 determines the next ground station that the Internet host 140-1 is to be in view of prior to the Internet host 140-1 losing contact with the ground station 136-2. In this manner, the IRCS 102 ensures that communications remain seamless to the client device 138 without causing disruptions even as the Internet host 140-1 moves and loses contact with different ground stations.

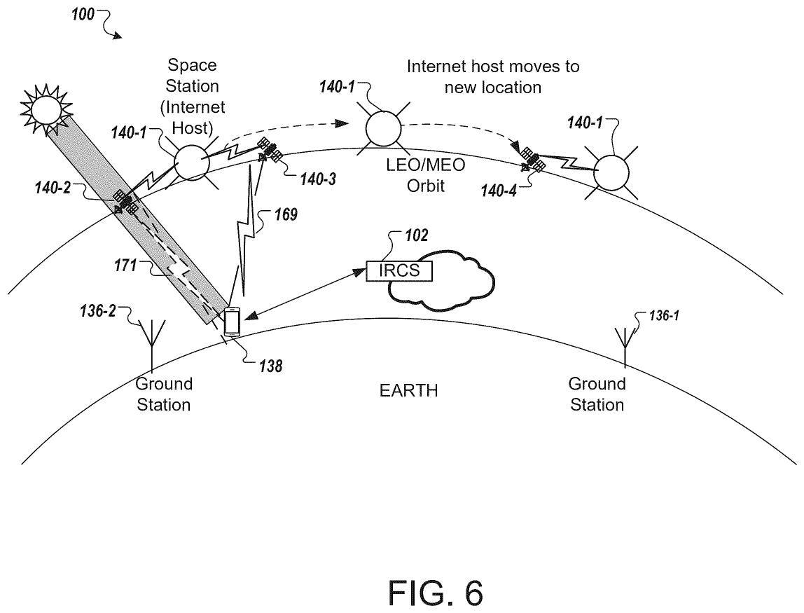

FIG. 6 is another block diagram that illustrates an example of system 100 for intelligently routing communications to an Internet host during a solar outage. The system 100 shown in FIG. 4 illustrates similar components and performs similar functions to those illustrated and described with respect to FIG. 1A.

In some implementations, the IRCS 102 can generate and provide new routing tables to the devices in system 100 during a solar outage. As illustrated in FIG. 6, during a solar outage, the IRCS 102 can reroute connection from a client device to the Internet host 140-1 in both uplink and downlink directions through a different satellite router, e.g., LEO satellite 140-3, while the current satellite router, e.g., LEO satellite 140-2 is under a solar outage. For example, the LEO satellite 140-2 can suffer a solar outage known by the IRCS 102 at a predictable time. Prior to the solar outage occurring, the IRCS 102 can change the routing between the client device 138 and the Internet host 140-1 through the LEO satellite 140-3, which is also in view of the client device at the time prior to the solar outage and during the solar outage. This is possible when multiple LEO satellites are in view of the client device 138 simultaneously. Moreover, the IRCS 102 also known which LEO and GEO satellites are in view to what client devices. Additionally, the IRCS 102 can determine, at a given time, who are the neighboring LEO satellites in contact with the Internet host 140-1 and the locations of the LEO satellites in orbit as they continuously rotate around the Earth. Accordingly, the IRCS 102 can intelligently route communications from the client device 138 using the a priori knowledge of solar outage events and the locations of the LEO satellites in orbit.

In some implementations, the IRCS 102 can intelligently route communications between devices in other manners during solar outages. In this case, the IRCS 102 can take advantage of the predictable nature of the solar outage to propose the DNS management solution to prevent access to the Internet host 140-1 when the Internet host 140-1 is accessed directly from the ground station 136-2 during a solar outage. The IRCS 102 can adjust the DNS TTL value associated with the Internet host 140-1 according to the predicted solar outage event. For example, the IRCS 102 can determine the upcoming start time and duration of a solar outage event. Accordingly, the IRCS 102 can adjust the DNS TTL value of the Internet host 140-1 to client devices in such a way that their DNS TTL values expire on a name resolver close to the time at which the solar outage occurs.

When the DNS TTL value expires, the name server resolver transmits a request to the authoritative name server to resolve the name to an IP address which replies with the CNAME of the IRCS 102. Then, the name resolver transmits a request to the IRCS 102 for the IP address, and the IRCS 102 operates in such a way that either the name to IP address will not be resolved, e.g., because the Internet host 140-1 is blocked for contact, or the IRCS 102 can resolve the name to an IP address that is associated with a different Internet host if a federation of hosts deployment is in place. These techniques implemented by the IRCS 102 can prevent user devices from accessing the Internet host 140-1 during any sun outage period or will redirect access to a different Internet host. Once the Internet host 140-1 is no longer under the solar outage condition, the IRCS 102 restores access to the Internet host 140-1 by changing the DNS entry, giving the name resolver the IP address of the Internet host 140-1. At this point, the IRCS 102 can prepare for the next predicted solar outage event. Therefore, by taking advantage of the predicted period or duration of a solar outage event, the IRCS 102 can support seamless transition of communications by intelligently rerouting traffic between devices.

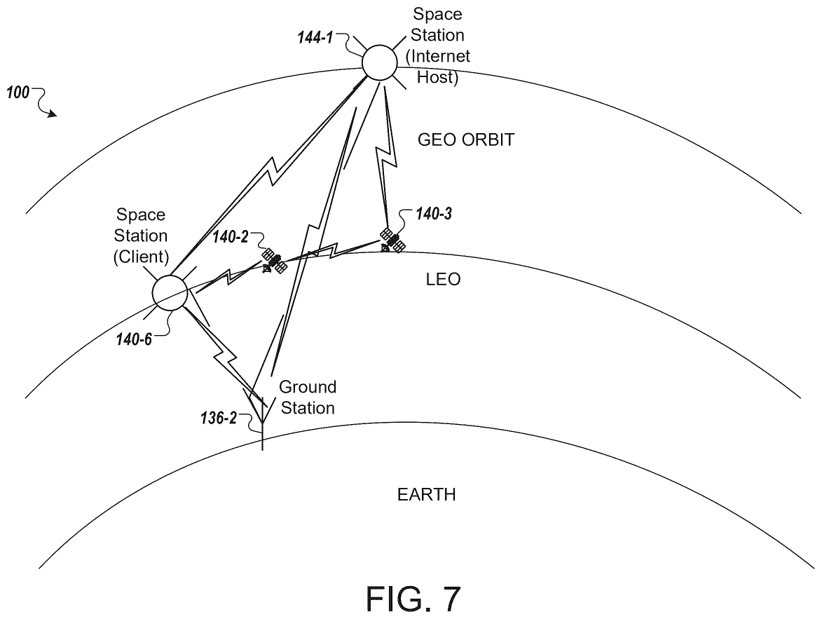

FIG. 7 is a block diagram that illustrates an example of a system 100 for intelligently routing communications from a client device in LEO orbit to an Internet host in a GEO orbit. The system 100 shown in FIG. 7 illustrates similar components and performs similar functions to those illustrated and described with respect to FIG. 1A.

In some implementations, the IRCS 102 can establish dynamic routing in order to establish a continuous path of communication between a client device and an Internet host. In some cases, the IRCS 102 can generate SID lists that enable client devices in space to access Internet hosts also in space. There are various dynamics in which this may occur. In some cases, a GEO orbiting client device may seek to access an Internet host also in GEO orbit. In this example, a direct ISL link between the GEO orbiting client device and the Internet host in GEO orbit may exist. The IRCS 102 may establish one or more LEO satellites that function as routers between the GEO orbiting client device and the GEO orbit, or the IRCS 102 may establish a terrestrial network fully or a hybrid network that encompasses the terrestrial network and the satellite LEO network.

In some cases, a client device in a LEO orbit may seek to access an Internet host in a GEO orbit. Here, the client device in the LEO orbit may (i) directly communicate with the Internet host in GEO orbit, (ii) require using a set of LEO satellites to reach the Internet host in GEO orbit, (iii) require using a terrestrial network to a gateway from where the Internet host in the GEO orbit can be accessed, or (iv) require using a hybrid network from where the Internet host in the GEO orbit can be accessed.

In some cases, a client device in a GEO orbit may seek to access an Internet host in a LEO obit. Here, the client device in the GEO orbit may (i) directly communicate with the Internet host in LEO orbit, (ii) require using a set of LEO satellites to reach the Internet host in LEO orbit, or (iii) require using a terrestrial network to a gateway from where the Internet host in the LEO orbit can be accessed, or (iv) require using a hybrid network from where the Internet host in the LEO orbit can be accessed.

Similarly, a client device in a LEO orbit may seek to access an Internet host in a LEO obit. Here, the client device in the LEO orbit may (i) directly communicate with the Internet host in LEO orbit, (ii) require using a set of LEO satellites to reach the Internet host in LEO orbit, or (iii) require using a terrestrial network to a gateway from where the Internet host in the LEO orbit can be accessed, or (iv) require using a hybrid network from where the Internet host in the LEO orbit can be accessed.

In some cases, a GEO client should be able to access the Internet host 144-1 in the GEO orbit directly using a GEO-to-GEO optical link. In some cases, the GEO client may not be able to communicate with the Internet host 144-1 in the GEO orbit using the GEO-to-GEO optical link due to, for example, a costly optical link, both devices are located in orbits in such a manner that precludes establishing a direct link, or other. Here, the access would need to be either through one or more LEO satellites routing or terrestrial ground routing to establish peer communications. The IRCS 102 can determine when the GEO client is unable to communicate with the Internet host 144-1. In response, the IRCS 102 can configure the Internet host 144-1 in the GEO orbit with a new SID list, such that the next hop is a LEO satellite, e.g., LEO satellite 140-3, or a ground station, e.g., ground station 136-2, and routing through one or more LEO satellites or the ground station to reach the space client 140-6.

On the other hand, the space client 140-6 may contact the ingress LEO satellite 140-2 in its view or a ground station 136-2. The IRCS 102 can provide the ingress entities or the space client 140-6 itself with the new SID list so that the ingress entities can forward traffic ultimately to the Internet host 144-1 in the GEO orbit.

In some implementations, a space client in GEO orbit may or may not directly access an Internet host in LEO orbit which is constantly moving. The space client in GEO orbit can rely on one or more LEO satellite routers to function as routers and ground stations when the Internet host in LEO orbit is not directly viewable.

When the space client is in LEO orbit and the Internet host is stationary in GEO orbit, the IRCS 102 propagates SID lists to ensure the space client can communicate with the Internet host in GEO orbit. In the event that the space client in LEO orbit is unable to communicate directly with the Internet host, the IRCS 102 can instruct the space client to communicate using one or more LEO satellite as routers or ground networks to reach the Internet host in GEO orbit. Given that a space client 140-6 may be a standard device, it is possible that the space client 140-6 may not be controlled by the IRCS 102 if it is not SRv6 capable. However, in some cases, the client device may be SRv6 capable, and the IRCS can deliver a SID list to the space client 150-6. Otherwise, the IRCS 102 can keep track of which LEO satellite or ground station the space client 140-6 that the client device is using as its ingress point. That IRCS 102 can configure the ingress LEO satellite or the ground station dynamically with the segment routing list so that that routing through the LEO satellites or ground station occurs properly to the Internet host in the GEO orbit.

In some implementations, the client device may be located in a LEO orbit and the Internet host can be located in the LEO orbit. In this case, both entities are constantly moving. If the client device in the LEO orbit and the Internet host in the LEO orbit are neighbors to one another, then the IRCS 102 can instruct these two devices to communicate with one another with ease. Otherwise, the IRCS 102 can instruct these two devices to communication through one or more LEO satellites that acts as routers, ground stations in a terrestrial network, or through a GEO satellite.

One such advantage of communicating through one or more LEO routers that are all orbiting and moving at the same rate is that the one or more LEO routers are relatively fixed to each other. In this manner, the IRCS 102 does not need to keep tracking of constant routing changes with a quick response time. If ISL links between satellites break or there is a sun outage, then the IRCS 102 can perform rerouting with new routing tables but not require a constant change.

In these cases, sun outages are applicable in client devices that are located in space and that are seeking to access the space host. In these cases, the previously described split routing and rerouting on a predictable sun outage holds true here, as will be managed by the IRCS 102.

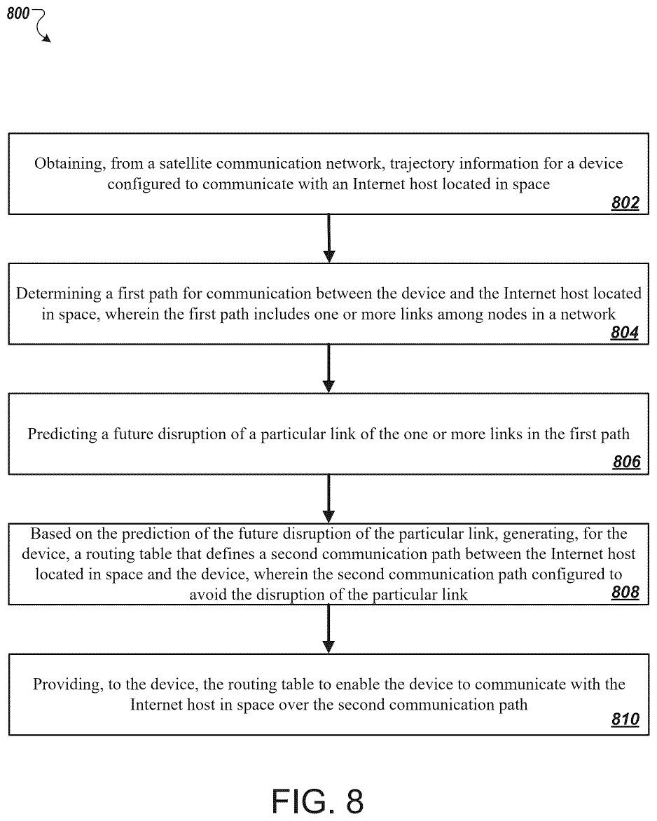

FIG. 8 is a flow diagram that illustrates an examples process 800 for intelligently routing communications in a hybrid communication network. A system, such as the IRCS 102 of system 100, can perform the process 800.

The system can obtain, from a satellite communication network, trajectory information for a device configured to communicate with an Internet host located in space (802). The device of the satellite communication network can include a ground station, a client device, or a satellite. The system can determine a trajectory of a satellite in the satellite communication network, determine a geographical location of a ground station on earth, and determine a geographical location of a client device on earth. The trajectory information can include location and/or velocity information of a particular device, to name some examples.

The system can determine a first path for communication between the device and the Internet host located in space, wherein the first path includes one or more links among nodes in a network (804). The first path can include, for example, a communication path from a client device to the Internet host located in space through a terrestrial network, a satellite network, or a hybrid network comprising the terrestrial network and the satellite network. In an example, an astronaut located on a space station can communicate with a ground station located on the Earth using the satellite networks in space provided by the communication system. In another example, a client device of a user on the ground may communicate with an Internet host located in space by routing communications directly through the satellite network in space, routing communications only through the terrestrial network on the ground, or routing communications in a hybrid manner that traverses both space and ground segments. Other examples are also possible.

The system can predict a future disruption of a particular link of the one or more links in the first path (806). In further detail, the system can predict various disruptions. These include, for example, terrestrial network congestion on the one or more links that satisfies a first threshold value, latency over the one or more links that satisfies a second threshold value, packet loss over the one or more links that satisfies a third threshold value, satellite network disruption over the one or more links according to the trajectory of the one or more satellites misaligning with the one or more client devices, an eclipse or solar outage that will likely impact the communication between the device and the Internet host, and, satellite network congestion over the one or more communication pathways that satisfies a fourth threshold value.

The system can predict these various disruptions for one or more links of a communication path. The one or more links can include satellite to satellite connection, ground station to satellite connection, client device to ground station connection, or client device to satellite connection, to name some examples. Other links are also possible.

Based on the prediction of the future disruption of the particular link, the system can generate, for the device, a routing table that defines a second communication path between the Internet host located in space and the device, wherein the second communication path configured to avoid the disruption of the particular link (808). Moreover, the system can generate, for multiple devices, a respective routing table that defines a respective communication path between the Internet host located in space and each respective device of the multiple devices. Here, each respective second communication path is configured to avoid the disruption of the particular link. In response, the system can provide, to each device of the multiple devices, the respective routing table to enable the respective device to communicate with the Internet host in space over the respective second communication path.

In some cases, the system generates, for each device, the routing table that defines the second communication path between the Internet host located in space and the device by replacing a satellite in the first path for communication between the device and the Internet host with one or more other satellites in the second communication path. In some cases, the system generates, for each device, the routing table that defines the second communication path between the Internet host located in space and the device by replacing a gateway in the first path for communication between the device and the Internet host with at least one of a different gateway and one or more additional satellites in the second communication path. Other examples are also possible.

The system can generate, for the device, the routing table that defines the second communication path configured to avoid the disruption of the particular link using various features. In further detail, the system can determine, for the device and for a current or future time, whether a communication pathway exists to the Internet host in space through one or more of a ground station and a satellite. The system can also determine, for each of one or more ground stations and for a current or future time, whether a communication pathway exists to the Internet host in space through one or more of the satellites. The system can also determine, for each of the one or more ground stations and for a current or future time, whether a communication pathway exists to the Internet host in space. Using this information, the system can store, in the routing table and for the device, the one or more ground stations, and the one or more satellites, a respective list of addresses of corresponding devices that enable communicating with the Internet host in space. The system generates the routing table that defines the second communication pathway causing the device to communicate with the Internet host located in space utilizing at least one of a terrestrial network, a satellite network, and a hybrid network that comprises the terrestrial network and the satellite network.

The system can store, in the routing table and for the device, the one or more ground stations, and the one or more satellites, the respective list of addresses by generating, for each of the device, the ground station, and the satellite, a segment routing version 6 (SRv6) segment ID (SID) list for the respective list of addresses, the SRv6 SID list instructing each device one or more subsequent devices to communicate with for sending communications to the Internet host in space. The system can store the generated SRv6 SID list in a respective routing table for the device that is communicating with the Internet host.

The system can determine whether the communication pathway exists to the Internet host in space by determining whether communication traffic flows from the device to the Internet host in space through at least one of the ground station, the satellite, or the ground station and the satellite.

In some implementations, the system can determine a respective path for communication between multiple devices and multiple respective Internet hosts located in space, where the each respective path includes one or more links among nodes in a network. The system can predict a future disruption of a particular link of the one or more links in a respective path. Based on the prediction of the future disruption of the particular link, the system can generate, for each device, a respective routing table that defines a respective communication path between a respective Internet host located in space and a respective device, wherein the respective path is configured to avoid the disruption of the particular link. In response, the system can provide, to each device, the respective routing table to enable the respective device to communicate with the respective Internet host in space over the respective path.

In some implementations, the system can determine trajectory information for the Internet host located in space in a GEO orbit and determine whether the device includes a capability to communicate with the Internet host located in space. In response to the system determining that the device includes the capability to communicate with the Internet host located in space, the system can generate, for the device, the routing table that defines the second communication path from the device to the Internet host located in space in the GEO orbit.

In some implementations, the system can determine trajectory information for the Internet host located in space in a GEO orbit and determine whether the device includes a capability to communicate with the Internet host located in space in the GEO orbit. In response to the system determining that the device does not include the capability to communicate with the Internet host located in space: the system can determine trajectory information of one or more satellites in LEO orbit and use the determined trajectory information to determine which of the one or more satellites in the LEO orbit the device views. In response, the system can generate, for the device, the routing table that defines the second communication path from the device to the Internet host located in space in the GEO orbit using the one or more satellites in the LEO orbit the device views.

In some implementations, the system can determine trajectory information for the Internet host located in space in a GEO orbit and determine whether the device includes a capability to communicate with the Internet host located in space in the GEO orbit. In response to the system determining that the device includes the capability to communicate with the Internet host located in space in the GEO orbit, the system can determine whether the device includes a capability to communicate with one or more LEO satellites. In to determining that the device includes the capability to communicate with the one or more LEO satellites, the system can generate, for the device, the routing table that defines the second communication path from the device to the Internet host located in space in the GEO orbit using the one or more LEO satellites as subsequent hops to the Internet host located in space in the GEO orbit.

The system can provide, to the device, the routing table to enable the device to communicate with the Internet host in space over the second communication path (810). In some cases, the system can define a start time and end time for the device to utilize the provided routing table. The start time and end time can include a time in the future based on a predicted outage, for example. In some cases, the system can instruct the device to utilize the provided routing table upon receipt.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining, from a satellite communication network, trajectory information for a device configured to communicate with an Internet host located in space;
determining a first path for communication between the device and the Internet host located in space, wherein the first path includes one or more links among nodes in a network;
predicting a future disruption of a particular link of the one or more links in the first path;
based on the prediction of the future disruption of the particular link, generating, for the device, a routing table that defines a second communication path between the Internet host located in space and the device, wherein the second communication path configured to avoid the disruption of the particular link; and
providing, to the device, the routing table to enable the device to communicate with the Internet host in space over the second communication path.

2. The computer-implemented method of claim 1, further comprising providing, to multiple devices, the routing table to table each device of the multiple devices to communicate with the Internet host in space over the second communication path.

3. The computer-implemented method of claim 1, further comprising:
based on the prediction of the future disruption of the particular link, generating, for multiples devices, a respective routing table that defines a respective second communication path between the Internet host located in space and each respective device of the multiple devices, wherein each respective second communication path is configured to avoid the disruption of the particular link; and
providing, to each device of the multiple devices, the respective routing table to enable the respective device to communicate with the Internet host in space over the respective second communication path.

4. The computer-implemented method of claim 1, further comprising:
determining a respective path for communication between multiple devices and multiple respective Internet hosts located in space, wherein the each respective path includes one or more links among nodes in a network;
predicting a future disruption of a particular link of the one or more links in a respective path;
based on the prediction of the future disruption of the particular link, generating, for each device, a respective routing table that defines a respective communication path between a respective Internet host located in space and a respective device, wherein the respective path is configured to avoid the disruption of the particular link; and
providing, to each device, the respective routing table to enable the respective device to communicate with the respective Internet host in space over the respective path.

5. The computer-implemented method of claim 1, further comprising providing, to the device, data indicating a start time and end time for the device to utilize the routing table.

6. The computer-implemented method of claim 1, wherein the device of the satellite communication network comprises a ground station, a client device, or a satellite.

7. The computer-implemented method of claim 1, wherein obtaining the trajectory information for the device configured to communicate with the Internet host in space comprises:
determining a trajectory of a satellite in the satellite communication network;
determining a geographical location of a ground station on earth; and
determining a geographical location of a client device on earth.

8. The computer-implemented method of claim 7, wherein predicting the future disruption of the particular link of the one or more links in the first path comprises one or more of:
predicting terrestrial network congestion on the one or more links that satisfies a first threshold value;
predicting latency over the one or more links that satisfies a second threshold value;
predicting packet loss over the one or more links that satisfies a third threshold value;
predicting satellite network disruption over the one or more links according to the trajectory of the one or more satellites misaligning with the one or more client devices;
predicting an eclipse or solar outage that will likely impact the communication between the device and the Internet host; and
predicting satellite network congestion over the one or more communication pathways that satisfies a fourth threshold value.

9. The computer-implemented method of claim 1, wherein generating, for the device, the routing table that defines the second communication path between the Internet host located in space and the device comprises replacing a satellite in the first path for communication between the device and the Internet host with one or more other satellites in the second communication path.

10. The computer-implemented method of claim 1, wherein generating, for the device, the routing table that defines the second communication path between the Internet host located in space and the device comprises replacing a gateway in the first path for communication between the device and the Internet host with at least one of a different gateway and one or more additional satellites in the second communication path.

11. The computer-implemented method of claim 1, wherein generating, for the device, the routing table that defines the second communication path configured to avoid the disruption of the particular link comprises:
determining, for the device and for a current or future time, whether a communication pathway exists to the Internet host in space through one or more of a ground station and a satellite;
determining, for each of one or more ground stations and for a current or future time, whether a communication pathway exists to the Internet host in space through one or more of the satellites;
determining, for each of the one or more ground stations and for a current or future time, whether a communication pathway exists to the Internet host in space; and
storing, in the routing table and for the device, the one or more ground stations, and the one or more satellites, a respective list of addresses of corresponding devices that enable communicating with the Internet host in space.

12. The computer-implemented method of claim 11, wherein storing, in the routing table and for the device, the one or more ground stations, and the one or more satellites, the respective list of addresses comprises generating, for each of the device, the ground station, and the satellite, a segment routing version 6 (SRv6) segment ID (SID) list for the respective list of addresses, the SRv6 SID list instructing each device one or more subsequent devices to communicate with for sending communications to the Internet host in space.

13. The computer-implemented method of claim 11, wherein determining whether the communication pathway exists to the Internet host in space using the device, the ground station, and the satellite comprises determining whether communication traffic flows from the device to the Internet host in space through at least one of the ground station, the satellite, or the ground station and the satellite.

14. The computer-implemented method of claim 1, wherein generating the routing table that defines the second communication path between the Internet host located in space and the device comprises generating the routing table that defines the second communication pathway causing the device to communicate with the Internet host located in space utilizing at least one of a terrestrial network, a satellite network, and a hybrid network that comprises the terrestrial network and the satellite network.

15. The computer-implemented method of claim 1, further comprising:
determining trajectory information for the Internet host located in space in a GEO orbit;
determining whether the device includes a capability to communicate with the Internet host located in space; and
in response to determining that the device includes the capability to communicate with the Internet host located in space, generating, for the device, the routing table that defines the second communication path from the device to the Internet host located in space in the GEO orbit.

16. The computer-implemented method of claim 1, further comprising:
determining trajectory information for the Internet host located in space in a GEO orbit;
determining whether the device includes a capability to communicate with the Internet host located in space in the GEO orbit;
in response to determining that the device does not include the capability to communicate with the Internet host located in space:
determining trajectory information of one or more satellites in LEO orbit;
using the trajectory information, determining which of the one or more satellites in the LEO orbit the device views; and
in response, generating, for the device, the routing table that defines the second communication path from the device to the Internet host located in space in the GEO orbit using the one or more satellites in the LEO orbit the device views.

17. The computer-implemented method of claim 1, further comprising:
determining trajectory information for the Internet host located in space in a GEO orbit;
determining whether the device includes a capability to communicate with the Internet host located in space in the GEO orbit;
in response to determining that the device includes the capability to communicate with the Internet host located in space in the GEO orbit, determining whether the device includes a capability to communicate with one or more LEO satellites;
in response to determining that the device includes the capability to communicate with the one or more LEO satellites, generating, for the device, the routing table that defines the second communication path from the device to the Internet host located in space in the GEO orbit using the one or more LEO satellites as subsequent hops to the Internet host located in space in the GEO orbit.

18. A system comprising:
one or more computers and one or more storage devices storing instructions that are operable, when executed by the one or more computers, to cause the one or more computers to perform operations comprising:
obtaining, from a satellite communication network, trajectory information for a device configured to communicate with an Internet host located in space;
determining a first path for communication between the device and the Internet host located in space, wherein the first path includes one or more links among nodes in a network;
predicting a future disruption of a particular link of the one or more links in the first path;
based on the prediction of the future disruption of the particular link, generating, for the device, a routing table that defines a second communication path between the Internet host located in space and the device, wherein the second communication path configured to avoid the disruption of the particular link; and
providing, to the device, the routing table to enable the device to communicate with the Internet host in space over the second communication path.

19. The system of claim 18, further comprising providing, to multiple devices, the routing table to table each device of the multiple devices to communicate with the Internet host in space over the second communication path.

20. One or more non-transitory computer-readable media storing software comprising instructions that are operable, when executed by one or more computers, to cause the one or more computers to perform operations comprising:
obtaining, from a satellite communication network, trajectory information for a device configured to communicate with an Internet host located in space;
determining a first path for communication between the device and the Internet host located in space, wherein the first path includes one or more links among nodes in a network;
predicting a future disruption of a particular link of the one or more links in the first path;
based on the prediction of the future disruption of the particular link, generating, for the device, a routing table that defines a second communication path between the Internet host located in space and the device, wherein the second communication path configured to avoid the disruption of the particular link; and
providing, to the device, the routing table to enable the device to communicate with the Internet host in space over the second communication path.
